(19) United States
(12) Patent Application Publication
(10) Pub. No.: US 2009/0248537 A1
(43) Pub. Date: Oct. 1, 2009

(54) COMMERCIAL TRANSACTION FACILITATION SYSTEM

(76) Inventor: Shahriar Sarkeshik, Northridge, CA (US)

Correspondence Address: THE ECLIPSE GROUP LLP, 10605 BALBOA BLVD., SUITE 300, GRANADA HILLS, CA, 91344, US

(21) Appl. No.: 12/097,016

(22) PCT Filed: Dec. 1, 2006
(86) PCT No.: PCT/US06/45997

§ 371 Date: May 4, 2009

Related U.S. Application Data
(60) Provisional application No. 60/741,849, filed on Dec. 1, 2005.
(60) Provisional application No. 60/790,316, filed on Apr. 7, 2006.

(51) Int. Cl. G06Q 30/00; G06F 17/30; G06F 17/40

(52) U.S. Cl. 705/26; 707/104.1; 707/3; 707/E17.014; 707/E17.044

(57) ABSTRACT

To facilitate the processing of commercial transactions, the system may be utilized to collect and store data related to product information, buyer information and seller information. A system is provided that collects and stores data from different sources (individual or company) and associates all or part of the data collected from the input of a single source with an identifier. The system, upon receipt of an identifier provided by a requester (software, person, system), can then provide the data associated with the identifier to the requester in a specific format or a format that will allow the requester to process the associated data.

### RELATED APPLICATIONS

The application relates to PCT International Application No. PCT/US2006/XXXXXX, titled “Data Exchange System”, filed Dec. 1, 2006, which is incorporated into this application in its entirety, and which claims priority to both U.S. Provisional Application Ser. No. 60/790,316 filed on Apr. 7, 2006, titled “Data Exchange System” and U.S. Provisional Patent Application Ser. No. 60/741,849 filed on Dec. 1, 2005, titled “Information Sharing System.” This application is a continuation-in-part of PCT International Application Serial No. PCT/US2006/XXXXXX filed on Dec. 1, 2006 and titled “Data Exchange System.” This application is also a continuation-in-part of PCT International Application No. PCT/US2005/025241 filed on Jul. 16, 2005 titled “Location Codes for Destination Routing”, which claims priority to U.S. Provisional Patent Application Ser. No. 60/588,585 filed on Jul. 17, 2004 titled “Method and System for Using Location Codes for Destination Routing”; U.S. Provisional Patent Application Ser. No. 60/622,511 filed on Oct. 26, 2004 titled “Location Codes for Destination Routing”; U.S. Provisional Patent Application Ser. No. 60/699,044 filed on Jul. 13, 2005 titled “Location Codes for Destination Routing”; and U.S. Provisional Patent Application Ser. No. 60/699,789 filed on Jul. 15, 2005 titled “Navigation System Interface System,” all to the above applications of which are incorporated in their entirety into this application. This application is also a continuation-in-part of PCT International Application No. PCT/US2005/025434 filed on Jul. 18, 2005 titled “Navigation Interface System”, which claims priority to U.S. Provisional Patent Application Ser. No. 60/588,585 filed on Jul. 17, 2004 titled “Method and System for Using Location Codes for Destination Routing”; U.S. Provisional Patent Application Ser. No. 60/622,511 filed on Oct. 26, 2004 titled “Location Codes for Destination Routing”; U.S. Provisional Patent Application Ser. No. 60/699,044 filed on Jul. 13, 2005 titled “Location Codes for Destination Routing”; U.S. Provisional Patent Application Ser. No. 60/699,789 filed on Jul. 15, 2005 titled “Navigation System Interface System”; and PCT International Application No. PCT/US2005/025241 filed on Jul. 16, 2005 titled “Location Codes for Destination Routing,” all to the above applications of which are incorporated in their entirety into this application. This application further claims priority to U.S. Provisional Application Ser. No. 60/790,316 filed on Apr. 7, 2006 and titled “Data Exchange System” and U.S. Provisional Patent Application Ser. No. 60/741,849 filed on Dec. 1, 2005 and titled “Information Sharing System”, both applications of which are incorporated in their entirety in this application.

### FIELD OF THE INVENTION

The invention relates to a system to enable the exchange of data and, in particular, a system to enable information of a type that is typically distributed or exchanged to facilitate and promote the processing of commercial transactions, including but not limited to, distributing and exchanging product information and financial information of buyers and sellers.

### BACKGROUND

The amount of available information is increasing at a rate higher than any other period in history. Such information is available from a variety of sources. During the last few decades, with the advent of computers, Internet and the worldwide web, a very efficient way of sharing data has been created. Now that there is an infrastructure for data sharing, attention has been shifted to finding, conveying, and extrapolating data. To that end, web browsers, websites and search engines, among other systems, have been created. All of which has facilitated the processing of commercial transactions through electronic means, which is commonly referred to as e-commerce.

E-commerce involves the buying and selling of goods over the Internet or through other electronic means, such as via a cell phone or other electronic device E-commerce transactions generally take place on a website or through a screen display provided by a seller accessible via communications with an electronic device, such as a cell phone, PDA, computer or other similar device. E-commerce sites range from a simple web page highlighting a single item to fully developed, on-line catalogs featuring thousands of products. The common theme in e-commerce sites is instant purchase, instant payment (if desired) and instant gratification for buyers and sellers.

E-commerce is changing the way people think and shop. Buying items electronically has become very desirable in today's fast-paced world. Individuals want to quickly find product information, price compare, check product availability, place orders and receive product orders in a very streamline, efficient manner. E-commerce purchasing is further desirable because it allows for individual to browse products endlessly in private and allows for buyers to place and receive orders without ever leaving their home. Some may even argue that it is just a matter of time before all sales-oriented companies will be required to provide some type of on-line or electronic purchasing to stay in business.

Although the goal of e-commerce is to streamline sales oriented transaction and to make it easier for purchaser to find information about products, certain steps in e-commerce transactions still remain a bit cumbersome. For example, individuals may still consume a large amount of time locating a specific product, performing price comparisons, checking product availability, product shipment costs and shipment times, and inputting payment, shipping and billing information.

Therefore, a need still exists for a system that will allow persons, such as individuals and companies, to quickly convey, retrieve and disseminate product information in a manner that is useful to the user, simplifies product research time and facilitates the processing of financial aspects of buying and selling products electronically.

### SUMMARY

To facilitate the processing of commercial transactions, a system may be utilized to collect and store data related to product information, buyer information and seller information. A system is provided that collects and stores data from different sources, including, but not limited to, individuals and/or companies, and associates all or part of the data collected from the input of a single source with an identifier. The system, upon receipt of an identifier provided by a requester, such as a software program, a person or a system, can then provide the data associated with the identifier to the requester in a specific format or a format that will allow the requester to process the associated data. Processing the data may include, but not be limited to, viewing product information, viewing event information and purchasing products and/or services.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE FIGURES

The invention can be better understood with reference to the following figures. The components in the figures are not necessarily to scale, emphasis instead being placed upon illustrating the principles of the invention. Moreover, in the figures, like reference numerals designate corresponding parts throughout the different views.

FIG. 1 is a flow diagram of one example of an implementation of an information sharing system (“ISS”).

FIG. 2 is a flow diagram of one example of an implementation of an ISS including a transaction processing module.

FIG. 3 illustrates one example of a user interface on a cellular telephone.

FIG. 4a illustrates one example of how an identifier for a particular product may be disseminated.

FIG. 4b illustrates one example of an input screen that may be displayed on a cell phone to input an identifier.

FIG. 4c illustrates one example of a screen display presenting corresponding data associated with the identifier.

FIG. 4d illustrates one example of a screen display that may be utilized if a buyer elects to purchase the product or service associated with the identifier.

FIG. 4e illustrates one example of a screen display confirming the purchase of the product or service associated with the identifier.

FIG. 5a illustrates one example of how an identifier for a particular event may be disseminated.

FIG. 5b illustrates another example of an input screen that may be displayed on a cell phone to input an identifier.

FIG. 5c illustrates another example of a screen display presenting corresponding data associated with the identifier.

FIG. 5d illustrates one example of a screen display that may be utilized if a buyer elects to purchase the product or service associated with the identifier.

FIG. 5e illustrates one example of a screen display confirming the purchase of the product or service associated with the identifier.

FIG. 6a illustrates another example of how an identifier for a particular product may be obtained.

FIG. 6b illustrates another example input screen that may be displayed on a cell phone to input an identifier.

FIG. 6c illustrates yet another example of a screen display presenting corresponding data associated with the identifier.

FIG. 7a illustrates yet another example of how an identifier for a particular product may be obtained.

FIG. 7b illustrates another example of an input screen that may be displayed on a cell phone to input a company identifier along with a product identifier.

FIG. 7c illustrates one example of a screen display presenting the corresponding data associated with the identifier.

FIG. 7d illustrates another example of a screen display that may be utilized if a buyer elects to purchase the product or service associated with the identifier.

FIG. 7e illustrates one example of a screen display presenting shipping options for the purchase of a particular product.

FIG. 7f illustrates one example of a screen display presenting order confirmation information.

FIG. 8a illustrates still another example of how an identifier for a particular product may be disseminated along with a group identifier for a particular company.

FIG. 8b illustrates another example input screen that may be displayed on a cell phone to input a group identifier along with a product identifier.

FIG. 8c illustrates another example of the screen display presenting corresponding data associated with the identifier.

FIG. 8d illustrates another example of a screen display presenting shipping options for the purchase of a particular product.

FIG. 8e illustrates another example of a screen display that may be utilized if a buyer elects to purchase the product associated with the identifier.

FIG. 8f illustrates another example of a screen display presenting order confirmation information.

FIG. 9 illustrates another example of how an identifier associated with a particular product may be disseminated.

FIG. 10a illustrates another example of how an identifier may be utilized to institute bidding on a product.

FIG. 10b illustrates another example input screen that may be displayed on a cell phone to input an identifier.

FIG. 10c illustrates another example of the screen display presenting corresponding data associated with the identifier.

FIG. 10d illustrates one example of a screen display that may be utilized to initiate bidding on a product.

FIG. 10e illustrates one example of a screen display that may be presented to allow a user to enter a bid for a particular product.

FIG. 10f illustrates one example of screen display confirming the receipt of a bid for a particular product.

FIG. 11a illustrates another example input screen that may be displayed on a cell phone to input a group identifier.

FIG. 11b illustrates another example of the screen display presenting corresponding data associated with the identifier.

FIG. 11c illustrates one example of a screen display showing product available for purchase and the prices associated with the product.

FIG. 11d illustrates one example of a screen display that may be presented to a user to allow a user to purchase a particular product using different purchase options.

FIG. 11e illustrates one example of a screen display providing confirmation information for the recording of a confirmed proxy order.

FIG. 11f illustrates one example of a screen that may be automatically displayed to determine whether a user desires to order a particular product when a user approaches a store that sells such product.

FIG. 12 illustrates one example of a screen display presenting a list of recent transactions to a user.

### DETAILED DESCRIPTION

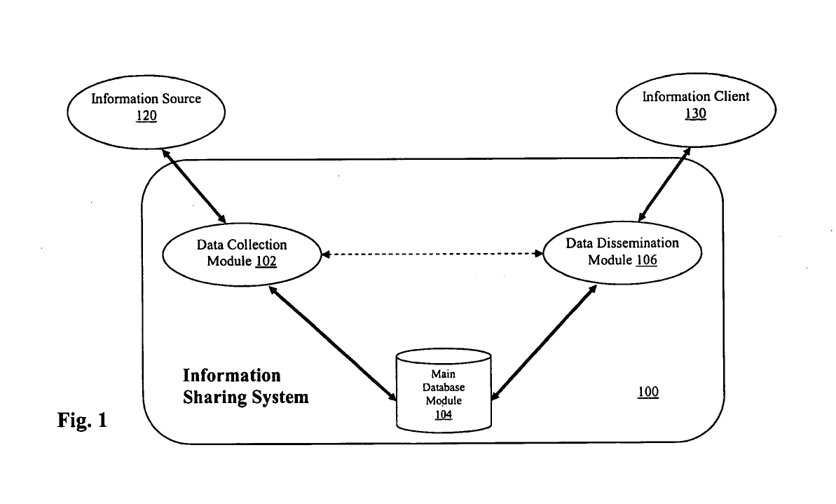

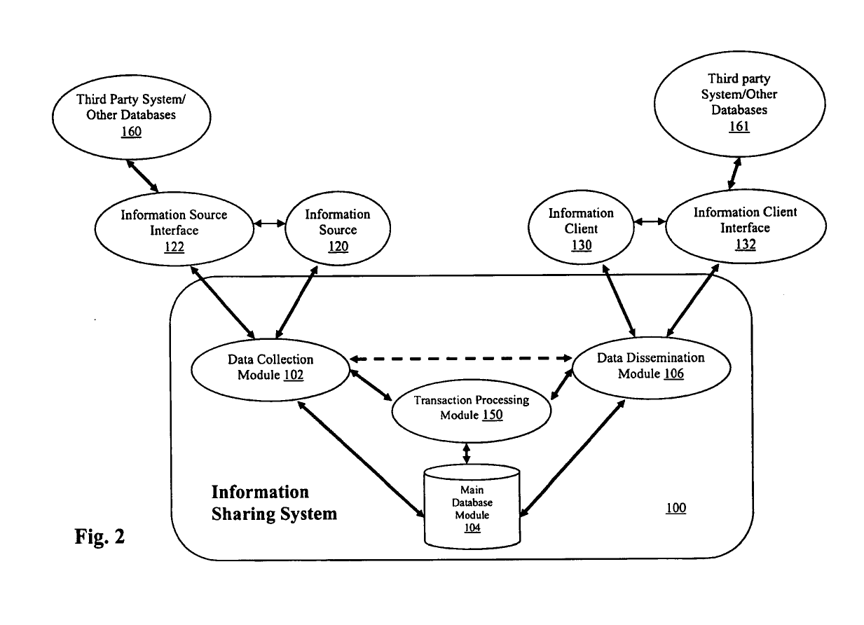

FIGS. 1 & 2 illustrate block diagrams of examples of two different implementations of an information sharing system (“ISS”) of the invention and its interaction with users, other systems and entities. In general, as illustrated in FIGS. 1-2, the ISS 100 includes a main database module 104 and a data collection module 102 for collecting data to be stored in the main database module 104. The data collection module 102, or other module in the ISS 100, can collect data from information sources 120, such as individuals and companies, and store the collected data in the main database module 104. The data collection module 102, or other module in the ISS 100, may assign or associates an identifier with all or part of the data collected from an information source 120.

The ISS 100 further includes a data dissemination module 106 for retrieving data from the main database module 104 associated with the identifier. The identifier can then be used by a requester to retrieve the data associated with the identifier utilizing the data dissemination module 106. A requester can be a person, such as a company or an individual, or another software application, program or interface module capable of communicating with the ISS 100 for the purposes of retrieving the information associated with the identifier in a specified format to allow the requester or requesting system to do one or more of the foregoing, among other things: display data, process data, manipulate data, format data, sort data, extrapolate data, display extrapolated data, store extrapolated data, display the associated identifier and/or store the associated identifier, utilize the data to process commercial transactions.

Different functions of the ISS 100 are described in FIGS. 1 & 2 as flow diagrams of various modules and are provided as examples to convey functionality of the ISS 100. Those skilled in the art will recognize that the functionalities described in the examples can be implemented in a variety of ways upon examination of the description contained in this application. The described modules may be combined, divided, recombined, integrated, and/or removed fully or partially to create other implementation of the invention. It is intended that all such additional systems, methods, features, implementations and advantages be included within this description, be within the scope of the invention, and be protected by the accompanying claims.

FIG. 1 is a flow diagram of one example of one implementation of an ISS 100 including two modules: a data collection module 102 and a data dissemination module 106. The data collection module 102 is responsible for receiving information from an information source 120, coupling the information with an identifier and storing the information and the identifier in the main database module 104. The data collection module 102 may provide appropriate user interface when the information source 120 is interfaced by a person. The user interface may be presented to the user in form of a web page, or screen display on an electronic device, that allows the user to input the desired information. Alternatively, in another example of one implementation the information source 120 may have its own user interface that communicates with data collection module 102. The user interface may include separate fields for individual data types. The data collection module 102 may have a mechanism to allow recalling and modifying of the data. The data collection module 102 may be connected to more than one information source 120 at a time. Similarly, an information source 120 may be connected to more than one data collection module 102 at a time.

Although all the examples only illustrate one main database module 104, the main database module 104 can be comprised of one or more separate databases. Further, more than one data collection module 102 can interface with a single database. Similarly, data collection module 102 and the information source 120 may be combined into one module included as part of the ISS 100.

The data gathered, handled or processed by the data collection module 102 may be of any type, including but not limited to, any type of entity information, contact information, event information, product information, multimedia data (including images, pictures, audio and/or video), financial information (including financial-information for processing transactions), links, hyperlinks, metadata, databases etc. As used in this application, “metadata” is any data about data. For example, metadata may include, but not be limited to, information in the form of binary, text, characters, graphics, images, pictures, audio, video, animation, files, files created by different programs, organized or unorganized data, information, databases, links, hyperlinks, programs, attributes or any other format for communicating information. For purposes of this application, “data” shall mean information, segments of information or the raw material of information. Data may further include useful, irrelevant and/or redundant information or raw material. Data may take various forms, including, but not limited to, numbers, letters, symbols, text, graphics, images, audio and/or video and may comprise a single fact or a collection of facts, raw facts, statistical data, metadata, binary digits, measurements, concepts, instructions, animation, databases, links, hyperlinks, programs, computer files, records, and etc.

The data collection module 102 couples one or more identifiers to the data received from the information source 120 and saves the identifiers into the main database module 104. Identifiers may be assigned in a variety of ways. For example, an identifier may be assigned randomly by data collection module 102 chosen from available identifiers. For example, an identifier may be assigned using an algorithm. Alternatively, the data collection module 102 may provide for a mechanism that allows the information source 120 to assign an identifier or choose one from a list provided. Part or all of the data provided by the information source 120 may be used to construct part or all of an identifier. For example, an email address or telephone number provided by an information source 120 may be used as an identifier. Another example is using the name provided by the information source 120 as part of an identifier. Since the same name may exist in the database, distinguishing character(s) may be added to the name to make it unique, e.g., Product 123. Another example is using the telephone area code or the zip code provided as part of the identifier. Although not necessary, the number of characters in a given identifier may be fixed or fixed for a given type of entity or class. In one example of one implementation, the type of characters used in an identifier may be restricted to numbers or numbers and symbols. Further, one or more security codes may be used in connection with each identifier to control access to certain data or authenticate ownership of financial data. A set of identifiers may be set aside for a particular information source 120, for a particular type of information source 120 or a particular class of information sources 120. Examples of types of data identifiers and how they may be generated can be found in PCT International Patent Application No. PCT/US2005/025241 titled “Location Codes for Destination Routing”, which application is incorporated in its entirety into this application. Identifiers may be generated in the same manner as the generation of location codes as described in PCT/US2005/025241.

There are many different ways that data may be associated with an identifier. One example of such association techniques is using information or web technology. This includes, but is not limited to, using HTML, XHTML, XML, PDF, application programs, various multimedia formats, tables, lists, text files, binary files, structured files, databases, SQL, programming languages such as Flash, Java, Java script, C, C+f, C#, among other programs, files, or languages, including proprietary association techniques etc. As web and information technology becomes more advanced with additional capabilities, these and other data association techniques may be used to enhance the user experience. A person familiar with the state-of-the-art may easily integrate such advancements for association of data with identifiers. Integration of such advancements and ability to use any known or new association technique is expected and is intended in the sprit of this invention.

The data dissemination module 106 is responsible for receiving an identifier from an information client 130 or requester, looking-up the associated data from the main database module 104 and retrieving all or part or all of the associated data. The data dissemination module 106 may provide appropriate user interface when the information client 130 is interfaced by a person and may provide the retrieved data to the information client 130 via a user interface. This user interface may be presented to the user in form of a web page, or other screen display, that allows the user to input the desired identifier. Alternatively, in another example of one implementation, the information client 130 may have its own user interface that communicates with data dissemination module 106. The data dissemination module 106 may also include a mechanism for processing the data before providing it. This processing may be based on the client's access right or based on the client's capabilities, preferences, requests or commands among others. Examples of processing include but not limited to filtering, sorting, constructing output in various formats (e.g. Text, HTML, XHTML, XML, Java applet, Flash etc.). Processing may take into account the current date, time, current location, circumstances, preferences, etc. Data dissemination module 106 may have the capability to be programmed or based on a request from information client 130 to automatically disseminate data to desired clients upon occurrence of an event. The types of events include, but are not limited to, changes in the corresponding data in the database, time, request, locations etc. The data provided by data dissemination module 106 may be delivered by a variety of methods including, but not limited to, using the same communication channel used for receiving the identifier, text message, email, VCard, HTML, XHTML, XML, database, multimedia formats etc. The delivery method may be pre-assigned or based on the client's capabilities, preferences or commands. The data dissemination module 106 may be connected to more than one information client 130 at a time. Similarly, an information client 130 may be connected to more than one data dissemination module 106 at a time.

Similar to the data collection module 102, more than one data dissemination module 106 can interface with a single database. Further, the main database module 104 may include more than one database. The data collection module 102 and data dissemination module 106 may communicate directly with one another to collect and provide information, as well as perform other task. This for example may occur when the data collection module 102 and the data dissemination module 106 communicate with more than one database. Further, although not shown, the data dissemination module 106 and the information client 130 may be combined into one module and included as part of the ISS 100.

The data collection module 102 and information source 120 as well as the data dissemination module 106, information client 130 and other modules discussed in this document may be interfaced through any medium including, but not limited to, directly, a network, wired network, wireless network, Internet, LAN, WAN, or any other communications network. Further, the ISS 100, information source 120, as well as information client 130 and other modules discussed in this document may operate on any platform, including, but not limited to, servers, computers, PDAs, cell phones, GPS systems, navigation system, other handheld and electronic storage devices, etc.

FIG. 2 is a flow diagram of another example of an implementation of an ISS 100 where a special purpose module, such as a transaction processing module 150 has been added. The transaction processing module 150 allows any type of information exchange, monitory exchange, commitment/authorization, bidding processes, contract among others between different entities. In one example of one implementation, the transaction processing module 150 may be used for a purchasing transaction. ISS 100 may interface to one or more third party system 160 and 161 to conduct appropriate transactions. In some implementations, the third party system 160 and 161 may be one integrated system. Examples of the third party system 160 and 161 may include, but not be limited to, any database of system that stores and/or process data on computers, servers, personal digital assistants, telephones, including but not limited to cellular telephones, televisions, vehicle control units, including navigation systems, or any other similar devices or systems, including, but not limited to, handheld devices and electronic storage devices, all of which may be accessible directly, or through networks, including but not limited to the Internet. Such third party system 160 and 161 may include contact/scheduling management programs, navigation systems, purchasing modules, product and service catalogs, product and service databases, financial transaction processing modules, including PayPal® and other credit card processing and payment services. PayPal® is a registered trademark of PayPal, Inc.

In operation, the ISS 100 may be implemented as a web-based application. Those skilled in the art will recognize that the ISS 100 may be a stand-alone application or may be implemented through a combination of software modules or programs, or a combination of hardware and software, any of which may run on one or more platforms, operating at one or more locations. The ISS 100 may be implemented as only a information retrieval system, as illustrated in FIG. 1, may include both an information retrieval system and a commercial transaction processing module 150, as illustrated in FIG. 2, or may just include a transaction processing module 150, capable of processing financial transactions utilizing identifiers associated with product information, buyer and seller information, including, but not limited to, financial information of both the buyer and the seller. Accordingly, the information retrieval system and transaction processing system may be integrated systems or may be implemented as separate systems. Further, any of the modules illustrated in FIG. 1-6 of PCT International Application No. PCT/US2006/XXXXXX, titled “Data Exchange System”, filed Dec. 1, 2006, which is incorporated into this application in its entirety, may be integrated, in all or in part, into the system illustrated in FIGS. 1 & 2 or implemented as separate systems that interface with the systems illustrated in FIGS. 1 & 2.

By way of example, if the ISS 100 was implemented as a web-application, the ISS 100 main module database 104 may be populated. The ISS 100 database may be populated with preexisting data, may be populate by compiling data from information sources 120, or a combination of both. When populating the database with information from information sources 120, the data maybe acquired in a number of different manners. As an example, the ISS 100 may include a web-interface, which may serve as the information source interface 122, accessible by information sources 120, such as individuals or companies to input data. Such a web-interface may be accessible by the information source 120 using web-browsers located on personal computers, personal digital assistants, telephones, including, but not limited to, cellular telephones, televisions, vehicle control units, including navigation systems, or an other similar devices or systems, including, but not limited to, handheld devices and electronic storage devices. Alternatively, as discussed above, the ISS 100, when operating as a stand-along program or part of the software module, program or combination hardware/software system, all or part of the associate software may be installed locally on any of the above listed devices.

In this example, the web-interface may be part of the data collection module 102 or part of the information source interface 122, which may be integrated as part of the data collection module 102. The individual or companies accessing the ISS 100 via the web interface to input data, may, as with most web-based applications, be required to create a user login and password. Once registered with the ISS 100, the individuals and companies may then be able to select different types of information that the individuals and companies desire to make available for dissemination to the public using the associated data identifier. For example, the users can enter product data, such as product pricing, availability, product details, shipping information, manufacturer information, owner or user's manual, return policies, company information and other information related to a product, service, manufacture, seller or related product lines. The ISS 100 may further provide the user with the ability to attach metadata to any of the foregoing data or to create data files that contain only metadata.

When the ISS 100 includes a transaction processing module 150, the database 104 may also be populated with financial information of registered users to allow the registered users to purchase products and/or services using identifiers associated with the users' personal financial information. When used to processing financial transactions, each identifier may further be associated with a security code to authenticate that an identifier is being used by the registered owner to process a transaction. The information associated with the security code may include, but not be limited to, a user's billing address, billing information, such as credit card, banking information, PayPal® account information, etc., preferred shipping address, preferred shipping method, or other information relevant or necessary to allow for the on-line purchase of the product or service. Those skilled in the art will recognize that it is not necessary to use security codes to processing commercial transactions utilizing the transaction processing module 150 of the ISS 100. Users that desire to purchase products and/or services may be required to enter their financial data into the ISS 100, or retrieve previously saved data, to buy and/or sell a product or service using the ISS 100.

In operation, for example, once users are logged on to the ISS 100, the users may be provided with a menu that allows them to select the type of data that they desire to store into the system and associate with an identifier. The ISS 100 may allow the users to update information, as necessary, change identifiers, password protect identifiers, associate more than one data file or type of data, each having its own identifier, with a single identifier. The ISS 100 could store the data in the ISS main database module 104 in accordance with known database storage methods, associating each data field with type identifiers to allow the data to be formatted and/or recognized by other applications when retrieved.

The ISS 100 may allow the user to select its identifiers, may randomly assign identifiers, may assign identifiers based upon user type or data type, or may use all or part of the input data to generate all or part of the identifier. Any other known method for generating data identifiers may also be utilized. Once the data is stored, the user can logon to the ISS 100 and change and/or modify data files as necessary to keep information being disseminated current. One or more passwords with one or more level of access rights may be, assigned to an identifier. Some of these passwords may be provided to third parties for purpose of adding, modifying and or accessing the associated data.

Additionally, individuals and companies 120 may provide data to the ISS 100 to populate the main database module 104 using information contained in third party systems/other databases 160. The information source 120 may request information from personal or company third party systems/other databases 160 to be download or synchronized with the ISS 100 main database module 104. Such information may be synchronized using programs, such as Microsoft® Exchange Server.

In addition to the information source 120 transferring data from third party systems/other databases 160 to the ISS 100, the data collection module 102 can mine for data contained in such third party systems/other databases 160. For example, the data collection module 102 may institute a search for all information relevant to a particular information source 120, such as vendors for a particular product, for inclusion of the data as part of the data associated with an identifier. The data collection module 102 may collect and organize such data prior to storing the data in the main database module 104.

Once the ISS main database module 104 is populated and is associated with identifiers, the data may be retrieved from the ISS main database module 104 using the identifier assigned to the stored data. As described above, the data may be retrieved from the ISS 100 using an interface application 132 or function or may allow a user to access a web interface to obtain desired information. In practice, companies and/or individuals could provide others with identifiers, for example, product identifiers to allow a person to obtain product information using the ISS. Further, as discussed above, users of the ISS 100 may associate identifiers with financial information for use by the user to quickly process commercial transactions. In this case, such information will likely only be accessible by the user in connection with a security code.

By way of example, a product identifier could be included on advertisements, catalogs, product brochures, flyer inserts or other similar advertisements, including electronic advertisements (web, television, radio etc.), to allow easy download and viewing of product information contained in the advertisements. Once in possession of this identifier, a person may be able to access the ISS 100 web interface, which could take the form of an information client interface 132 and which may be integrated into a website, web browser, search engine or etc. The web interface could, for example, provide users with a “GET INFORMATION” selection. If this option is selected, the user may then be taken to a screen that asks the user to input the identifier. Alternatively, in another example of one implementation, the web interface could include an input area for inputting the product identifier without the necessity of being redirected to another website or screen. Once entered, the ISS 100 could display the product information to the user and confirm that the requested information is the desired information. From there, the ISS 100 may provide the user with the option of viewing further information, sending the information to themselves in the form of an email, a text message, a word document, or another other desirable electronic format for receiving the data, or may allow the user to purchase (bid on etc.) the product or service associated with the identifier or send the address to a navigation system to calculating routing information among other capabilities.

Optionally, the user requesting the information may also be able to register with the ISS 100. As a registered user, the user maybe able to save personal information and/or financial information that could enable the user to initiate a commercial transaction to, for example, purchase the product associated with the identifier. Accordingly, the user could enter a product identifier to retrieve product information; the user may then, utilizing the user's security code, purchase the product. Alternatively, in another example of one implementation, when the ISS 100 incorporates only a transaction module, product information may be obtained from any source, such as search engine, website, database or combination thereof; however, the purchase of the product may take place using the user's security code to expedite the purchase of the product. Further, those skilled in the art will recognize that it is not necessary to use a security code to purchase the product and/or service using the ISS 100. The ISS 100 may allow for a user to enter personal and financial information to purchase desired goods and/or service, enter a user's security code or both.

In the same manner that a third party systems/other databases 161 may obtain information from the ISS 100, the ISS 100 may provide information to such third party systems/other databases 161, for example, to up date prior information provided by the ISS 100.

Additionally, all the databases, systems, modules and interfaces used to provide information to the ISS 100 such as third party systems/other databases 160, information source interface 122 and information source 120 may be integrated with its counterparts used to gather information from the ISS 100, including, but not limited to, the third party systems/other databases 161, information client interface 132 and information client 130.

In one example of an implementation, a product that may have an identifier assigned to it or simply listed under a member/user's personal identifier. In this example, the seller of the product is registered to receive money. The methods of receiving money include but are not limited to bank accounts, a credit card accounts, a PayPal® account, smartcards, local account etc. A local account, including, but not limited to a bank account, may be setup for the users where money can be deposited and/or withdrawn. Another member/buyer that has been signed up with appropriate (required) information may purchase the item. For example, the required information may include name, address, telephone number, security code and a method of payment, which may include bank account, credit card account, a PayPal® account, smartcards, local account etc.

Any user application can be designed to include features to allow data retrieval from the ISS 100. Such user application can allow interface with application designed to provide the application with access to, and use of, ISS 100 information. For example, a cell phone, computer program, website, PDA, navigation system or other handheld devices could include a built-on or add-on functionality that could retrieve and display information associated with a product identifier and/or could further process a commercial transaction using an identifier and/or security code. Further, the product identifier can be displayed as part of a database of stored information or could be temporarily retrieved and displayed. In the case where the product information is associated with company or store information, the application could include a feature that would allow the company or store information to be stored in a contact management system or could be used to retrieve location or mapping information, for example, using a navigation system. In this manner, whenever the store or company contact information is accessed, the information can be updated, if necessary, by accessing the ISS 100 main database module 104 and recording any changes. Optionally, the contact information can always be retrieved from the ISS 100 when accessed. In this case, it may not be necessary to store contact information locally.

This data retrieval function can be utilized in connection with any application by allowing for the input of the identifiers and the retrieval associated information from an ISS 100, including but not limited to, e-commerce websites, contact/scheduling management programs, word processing programs, and navigations systems. Further, these applications can run on, or be accessible by, personal computers, personal digital assistants, telephones, including but not limited to cellular telephones, televisions, vehicle control units, including navigation systems, or any other similar devices or systems, including, but not limited to, handheld devices and electronic storage devices.

As indicated above, the ISS 100 may also be able to allow users to associate metadata with an identifier. This may include any type of information that might be desired to be accessed and retrieved by a person. By associating metadata with identifiers, an ISS 100 user may also be able to create a personalized account that would allow the user to compile and receive certain metadata in a given format. For example, companies may provide weekly or daily specials in the form of metadata. A user can then request that all the information associated with a number of identifiers be complied into one document and received by the user. In this manner, a user may be able to receive one .pdf file, text message, email, VCard, HTML, XHTML, XML, database, multimedia formats etc, for example, that includes all the daily adds for the user's five favorite stores. The user could then create personalized documents, or papers, generated from information compiled from the user's favorite sources.

A hyperlink, menu selection or button may start or initiate the retrieval of data through the ISS 100 using an identifier. A similar hyperlink may be attached to an email, displayed on a website or provided to a user in another manner. When selected, the hyperlink would retrieve the associated data from the ISS 100 and add the data to the relevant user's application, such as a contact manager database application. The selection of the hyperlink could also create a V-card or equivalent and email the V-card to the users identified destination. The selection of the hyperlink may initiate a purchasing or bidding process. Other options may be provided to the user by right clicking on an identifier in any program including viewing or initiating the retrieval of data.

An identifier may be communicated via variety of methods including but not limited to email, text message, instant message, website, paper advertisement, electronic advertisement, radio, television, tags, etc. A program such as an information client interface 132 may be devised to analyze the content of a document or file such as an email, text message or instant message and in case it contains an identifier, give the user the ability to retrieve, initiate purchasing or bidding and/or store the associated data among other activities.

In one example of one implementation, an information client 130 or an information client interface 132 may register with a data dissemination module 106 asking to be notified if the data associated with an identifier is modified. Alternatively, a data dissemination module 106 may automatically notify all the accessible information clients 130 or information client interfaces 132 that have accessed a certain identifier when the information associated with that identifier is modified.

### I. ISS Uses of Identifiers

As recognized above, the invention may be implemented in a number of different implementations include a number of different modules and interfaces, permitting the interfacing to various databases, applications and with users of the ISS 100. Any implementation is within the scope of this invention if it allows one or more databases to be populated with specific data regarding individuals, companies and professional and consumer products and services, allows a second party to retrieve information using an identifier associated with such data and allows the processing of a commercial transaction based upon such data.

As set forth above, an identifier may be associated with any type of data, including, but not limited to, contact information, event information, personal information, such as medical or financial records, product information, financial information, seller specific information, buyer information and other information, including information necessary to facilitate a commercial transaction. Further, more than one identifier may be associated with the same information or the information can be segmented such that certain of the information may be associated with one identifier and other information may be associated with a separate identifier. The associated data may or may not overlap with other identifiers. As further explained below, in addition to associating data with an identifier, the data may further be associated with one or more security codes that prevent the release of all or part of the data associated with the identifier unless the person requesting the information provides the security code(s), as well as the identifier when requesting associated data.

To retrieve data associated with an identifier, the identifier may be provided to a person who desires to retrieve the associated data. The identifier may be verbally provided to a person, for example, via radio or television, or may be provided to a person in writing, in the form, for example of print, such as a flyer, newspaper, magazine, catalog or advertisement, or may be disseminate electronically in the form of an email, electronic document, screen display, banner advertisement, or etc. In the commercial context, identifiers may be associated with companies, buyers, sellers, specific products, financial data, etc. When the identifier is associated with a company, a product, seller, or etc., the identifier may appear in conjunction with any means to help facilitate the sale of the associated product or services, including but not limited to, advertisements, whether distributed electronically, by mail, in flyers, or other common forms of the disseminating seller and product information. The identifier may be displayed in text or may take the form of a link that will allow the user to automatically retrieve associated data by selecting the identifier, for example, by double clicking on the identifier. Once the data is retrieved, it may be saved by the user manually or automatically in a program or application appropriate for storing, retrieved data, processing or manipulating the associated data or allowing for the processing of a commercial transaction relating to the associated data.

As one example of one implementation, data associated with an identifier may be retrieved, stored, processed and reassembled by a website, program or software module designed to specifically retrieve and/or process information related to an identifier for use by the person requesting the associated information. For example, the data may be retrieved utilizing a program to retrieve the information associated with the identifier upon the entry of an identifier in the program. The program may be in a language such as Java and may represent part or all of an information client 130, information client interface 132 or data dissemination module 106 (see FIGS. 1 and 2). The program may be accessible locally on a user's personal computer, personal digital assistant, telephone, including but not limited to cellular telephones, television, vehicle control unit, including navigation systems, or any other similar devices or systems, including, but not limited to, handheld devices and electronic storage devices. Additionally, such programs may be accessible remotely using a web browser that is available on any of the above listed storage devices.

In this example, the manner in which the associated data may be used, processed, presented and stored may be at least partially determined by this program. For example, this program may be able to identify the type of data and recognize how to process, store and present the data to the requester. The associated data, when retrieved by the program may, for example, include as part of the data string, identifying information that informs the retrieving program of the type of data. For example, the data string may include identifying data that will allow the program to distinguishing product data from financial data, for example.

Additionally, in one example of one implementation, the construction of an identifier, in addition to or exclusive of the associated data, may provide information to the program responsible for retrieving, displaying, storing and/or processing the data regarding how the associated information may need to be handled. For example, all identifiers could be made up of equal length number sequences. The identifiers, by way of example only, could be similar in construction to telephone numbers, but constructed to exclude telephone numbers. Different number ranges may be set aside for different type of information (e.g. contact, address, group contact, event, financial information etc.). A simple cell phone interface may be used to enter a telephone number to be dialed or identifier to retrieve information. In this regard, there would be no need to invoke another program or go to a different area in the phone for different applications to enter an identifier. Due to the structure of the identifier, an identifier could be distinguished between other types of data entry numbers, such as a phone number. Thus, when a series of numbers is entered into a cell phone, it could be determined if the series of numbers represent a telephone number, in which case the number is dialed. However, if the number is an identifier, an ISS 100 may be accessed, associated information retrieved and/or saved. The numbering range of the identifier may be used to assist in determining what needs to be done with the data. In a sense, in this example, not only the identifier is used as data but also command. Alternatively, the associated data to an identifier may also be used to determine the course of action. For example the associated data may include a “Type” field or other data string that will identify the type of associated data that is being retrieved or send to the requesting program. Further, the associated data may include other fields that instruct an information client 130 or an information client interface 132 (see FIGS. 1 and 2) how to handle the data. Symbols, such as “#”, may also be used to distinguish the number from a telephone number.

In general, each identifier may have a type associated with it. Persons skilled in the art will understand and appreciate that the data structures outlined here are for presentation and reference only. Many other data structures are possible and well understood. In one example of one implementation, an entity's identifier may be the telephone number for the entity plus an additional or alternate character. For example, a company having a 1-800-555-1234 may have 2-800-555-1234 as its identifier. This will make the numbers mutually exclusive but at the same time make it easy to remember and reduces the number of numbers to remember. Further, the identifiers may include a character or number that identifies whether the number is associated with a product, and event, personal information, group of companies, group of individuals, etc. As previously referenced, examples of types of data identifiers and how they may be generated can be found in PCT International Patent Application No. PCT/US2005/025241 titled “Location Codes for Destination Routing”, which application is incorporated in its entirety into this application.

### II. ISS Application Examples

Following are various application examples of several different implementation of the invention.

A. Products

Using FIGS. 1 and 2 as reference, in one example of one implementation, the data provided by an information source 120 to a data collection module 102 may be as follows:

| Field Name | Data |
|---|---|
| Owner | Identifier (cross references owner information) |
| Product Name | Miracle Vitamin |
| Description | Detailed Description |
| Price | $29.92 |
| Shipping-A (Next day) | $5 |
| Shipping-B (Ground) | $2 |
| Number in Stock | Ref Third Party System |

Here, an available identifier is assigned to a product. The identifier may be assigned to the data based on an algorithm, may be assigned utilizing another method, may be randomly selected by the ISS, may be selected by the information source 120 or by the user. Above data in conjunction with the chosen identifier may then be saved in the main database module 104. The owner is identified by the identifier. Product name, product description, price, shipping options are inputted manually, automatically by information source interface 122 reading from a third party system 160 or semi-automatically via an interface file. The number in stock may be read real-time as needed from the third party system 160. All other information may also be referenced to a third party system 160. The owner here assumed to be a contact with financial account information. An information client interface 132 acting as a “Master” may enable a user to input an identifier. The information client interface 132 forwards the identifier to the data dissemination module 106. Data dissemination module 106 may cross references the identifier, lookup the associated data and, as necessary, reference a third party system 160. The data dissemination module 106 can then assemble the data and forwards it to the information client interface 132. The information client interface 132, after allowing the user to verify the data including the price availability etc., allows the user to request a transaction, e.g., buy the product. In one example of one implemenation, the transaction processing module 150 may verifies the caller ID/telephone number/cell phone ID and asks for the security code to authenticate the transaction. Upon receiving the security code from the user and verifying it, the transaction processing module 150 may then debit the appropriate user account and credit the appropriate seller account, (e.g., owner account). This might be done by interfacing via the information client interface 132 to one or more third party systems. Appropriate verifications and transaction receipts may be sent to both parties.

Those skilled in the art will recognize that other means for collecting financial information to process the transaction using a transaction processing module may be utilized. Further, other means for authenticating the transaction may also be employed, such as contacting the buyer directly for verification, using a security code, secured login or other using other data for verification.

B. Multiple Products

Using FIGS. 1 and 2 as reference, in one example of one implementation, the data provided by an information source 120 to a data collection module 102 may be as follows:

| Field Name | Data |
|---|---|
| Owner | Identifier (cross references owner information) |
| Product Name 1 | Ref Third Parry System (Ref code) |
| Description 1 | Ref Third Party System (Ref code) |
| Price 1 | Ref Third Party System (Ref code) |
| Shipping-A1 (Next day) | Ref Third Party System (Ref code) |
| Shipping-B1 (Ground) | Ref Third Party System (Ref code) |
| Number in Stock 1 | Ref Third Party System (Ref code) |
| Product Name 2 | Ref Third Party System (Ref code) |
| Description 2 | Ref Third Party System (Ref code) |
| Price 2 | Ref Third Party System (Ref code) |
| Shipping-A2 (Next day) | Ref Third Party System (Ref code) |
| Shipping-B2 (Ground) | Ref Third Party System (Ref code) |
| Number in Stock 2 | Ref Third Party System (Ref code) |
| Product Name n | Ref Third Party System (Ref code) |
| Description n | Ref Third Party System (Ref code) |
| Price n | Ref Third Party System (Ref code) |
| Shipping-An (Next day) | Ref Third Party System (Ref code) |
| Shipping-Bn (Ground) | Ref Third Party System (Ref code) |
| Number in Stock n | Ref Third Party System (Ref code) |

Here, an available identifier may be assigned to multiple products. The identifier may be assigned to the data based on an algorithm, may be assigned utilizing another method, may be randomly selected by the ISS or may be selected by the information source 120. The above data in conjunction with the associated identifier may be saved in the main database module 104. The owner is identified by the identifier. Product name, product description, price, shipping options, number in stock may be read real-time as needed from the third party system 160 based on a reference code (“Ref Code”). An information client interface 132 acting as a “Master” may enables a user to input an identifier. The information client interface 132 may forward the identifier to the data dissemination module 106. Data dissemination module 106 may then cross references the identifier, lookup the associated data and, as necessary, reference a third party system 160. The data dissemination module 106 may assemble the data and forward it to the information client interface 132. The information client interface, after allowing the user to choose a product and verify the data including the price availability etc., may allow the user to request a transaction, such as buying the product.

If the user requests to buy the product, the transaction processing module 150 may then authenticate the user by, for example, verifying the caller ID/telephone number/cell phone ID when using a cell phone, or verifying other personal data, and/or asking for the user's security code or using secured login etc. Upon receiving the security code from the user and verifying it, the transaction processing module 150 debits the appropriate user account and credits the seller account, e.g., owner account. This might be done by interfacing via an information client interface 132 to one or more third party systems. Appropriate verifications and transaction receipts may be sent to both parties.

Those skilled in the art will recognize that other means for collecting financial information to process the transaction using a transaction processing module may be utilized. Further, other means for authenticating the transaction may also be employed, such as contacting the buyer directly for verification, using a security code, using secured login or using other data for verification.

C. Product at Multiple Locations

Using FIGS. 1 & 2 as reference, in one example of one implementation, the data provided by an information source 120 to a data collection module 102 may be as follows:

| Field Name | Data |
|---|---|
| Product | Identifier |
| Product Name 1 | Miracle Vitamin |
| Description 1 | Detailed Description |
| ID 1 | Seller identifier 1 |
| Price 1 | Ref Third Party System (Ref code) |
| Shipping-A1 (Next day) | Ref Third Party System (Ref code) |
| Shipping-B1 (Ground) | Ref Third Party System (Ref code) |
| Number in Stock 1 | Ref Third Party System (Ref code) |
| ID 2 | Seller identifier 2 |
| Address 2 | Ref Third Party System (Ref code) |
| Price 2 | Ref Third Party System (Ref code) |
| Shipping-A2 (Next day) | N/A |
| Shipping-B2 (Ground) | N/A |
| Number in Stock-2 | N/A |
| ID 3 | Seller identifier 3 |
| Address 3 | Ref Third Party System (Ref code) |
| Price n | Ref Third Party System (Ref code) |
| Shipping-An (Next day) | N/A |
| Shipping-Bn (Ground) | N/A |
| Number in Stock n | N/A |
| IDn | Seller identifier n |
| Address n | Ref Third Party System (Ref code) |

Here, an available identifier may be assigned to a product that is available from multiple retailers. The identifier may be assigned to the data based on an algorithm, may be assigned utilizing another method or may be randomly selected by the ISS 100. The above data in conjunction with the chosen identifier may be saved in the main database module 104. The product is identified by an identifier and seller information may also be identified by an identifier. Product name, product description, price, shipping options, number in stock is read real-time as needed from the third party system 160. An information client interface acting as a “Master” may enable a user to input an identifier. The information client interface 132 may forward the identifier and, when using a navigation system or cell phone, the GPS coordinates of the requester, to the data dissemination module 106. The data dissemination module 106 cross references the identifier, retrieves a number of closest locations carrying the product associated with the identifier and, as necessary, references a third party system 160. The data dissemination module 106 may then assembles the data and forwards it to the information client interface 132. The information client interface 132, after allowing the user to verify the data, including the price, availability, shipping information, etc., allows the user to choose one of the sellers.

If the user requests to buy the product, the transaction processing module 150 may then authenticate the user by, for example, verifying the caller ID/telephone number/cell phone ID when using a-cell phone, or verifying other personal data, and/or asking for the user's security code. Upon receiving the security code from the user and verifying it, the transaction processing module 150 debits the appropriate user account and credits the seller account, e.g., owner account. This might be done by interfacing via an information client interface 132 to one or more third party systems. Appropriate verifications and transaction receipts may be sent to both parties. The system may further provide the user with the option of obtaining routing direction to the store.

Those skilled in the art will recognize that other means for collecting financial information to process the transaction using a transaction processing module may be utilized. Further, other means for authenticating the transaction may also be employed, such as contacting the buyer directly for verification, using a security code, secured login or using other data for verification.

In this example, one product may be referenced with many different identifiers. The manufacturer of a product may have an identifier that indexes multiple sellers, while each seller may set a different identifier. For example a print, radio or TV ad for a given seller may give the audience a product identifier that shows them as the only retailer. The manufacturer on the other hand would like to list all the available sellers under a different identifier so the customer may find the most convenient one.

D. Contact with Financial Account Information

Using FIG. 2 as reference, in one example of one implementation, the data provided by an information source 120 to a data collection module 102 may be as follows:

| Field Name | Data |
|---|---|
| Name | John |
| Last Name | Doe |
| Company | Radio R US |
| Title | Senior sales representative |
| Tel | (310) 879-2787 |
| Cell Phone | (310) 738-3838 |
| Email | JD@RDU.com |
| Street Number | 76280 |
| Street Name | First street. |
| City | Santa Monica |
| State | CA |
| Zip | 90123 |

Internal Secure Access Only

{

| | |
|---|---|
| Bank Account 1 | Routing Number + Account Number +.... |
| Bank Account 2 | Routing Number + Account Number +.... |

| | |
|---|---|
| Credit card 1 | VISA (Account Number) + code |
| Credit card 2 | Master Card (Account Number) + code |
| Merchant Account | Type (Account Number) |
| Local Account | Type (Account Number) |
| Receipt ID | 8939-9387-8398-2673 |

| | |
|---|---|
| security code | 56738 |
| } | |

Here, a series of identifiers may be provided to the user to choose from. Alternatively, the identifier may be assigned to the data based on an algorithm, may be assigned utilizing another method, may be randomly selected by the ISS 100 or may be selected by the information source 120. The above data, in conjunction with the chosen identifier, may be saved in the main database module 104.

This type of account might be utilized by an individual or a company. The data marked for “Internal Access only” may be only be accessible internally, for secure transactions and may be only available to be modified and utilized by the user. Further, this information may be used by the transaction processing module 150 to verify and authenticate a user and to pay for products or services and/or receive payment from another user. In one example, an information client 130 running on the user cell phone acting as a “Master” may enable a user to input an identifier. The information client 130 forwards the identifier to the data dissemination module 106. The data dissemination module 106 may cross reference the identifier, retrieve the associated data and forward the data to the information client interface 130. The information client interface 132, after allowing the user to verify the data, including the price, may then allow the user to initiate a commercial transaction, such as buying the product.

If the user requests to buy the product, the transaction processing module 150 may then authenticate the user by, for example, verifying the caller ID/telephone number/cell phone ID when using a cell phone, or verifying other personal data, and/or asking for the user's security code. Upon receiving the security code from the user and verifying it, the transaction processing module 150 debits the appropriate user account and credits the seller account, e.g., owner account. This might be done by interfacing via an information client interface 132 to one or more third party systems. Appropriate verifications and transaction receipts may be sent to both parties.

Those skilled in the art will recognize that other means for collecting financial information to process the transaction using a transaction processing module may be utilized. Further, other means for authenticating the transaction may also be employed, such as contacting the buyer directly for verification, using a security code, secured login or using other data for verification.

In this example, an identifier may be associated with the contact information, which may be publicly disseminated, while the financial information may be associated with a separate identifier and may be protected via a security code, as further explained below.

E. Using Security Code

Using FIG. 2 as reference, in one example of one implementation, the data provided by an information source 120 to a data collection module 102 may have the following fields:

| Field Name | Data |
|---|---|
| Name | John |
| Last Name | Doe |
| Company | Radio R US |
| Title | Senior sales representative |
| Tel | (310) 879-2787 |
| Cell Phone | (310) 738-3838 |
| Email | JD@RDU.com |
| Street Number | 76280 |
| Street Name | First street. |
| City | Santa Monica |
| State | CA |
| Zip | 90123 |

Internal Secure Access Only

| | |
|---|---|
| { | |
| Bank Account 1 | Routing Number + Account Number +.... |
| Bank Account 2 | Routing Number + Account Number +.... |
| Credit card 1 | VISA (Account Number) + code |
| Credit card 2 | Master Card (Account Number) + code |
| Merchant Account | Type (Account Number) |
| Local Account | Type (Account Number) |
| Receipt ID | 8939-9387-8398-2673 |
| security code | 56738 |
| Security Code | ******** |
| } | |

Here, a series of identifier may be provided to the user to choose from. Alternatively, the identifier may be assigned to the data based on an algorithm, may be assigned utilizing another method, may be randomly selected by the ISS 100 or may be selected by the information source 120. The above data, in conjunction with the chosen identifier, may be saved in the main database module 104.

In this example, an identifier may be assigned to the contact information and separate identifier may be assigned to represent the financial information. To further secure the financial information and to assist with authenticating the utilization of the identifier, a security code may also be assigned to control access to the financial data. The security code may be chosen and entered by the user. The above data, in conjunction with the chosen security codes may be saved in the main database module 104.

In one example, an information client 130 running on the user cell phone acting as a “Master” may enable a user to input an identifier, such as a product identifier. The information client 130 forwards the identifier to the data dissemination module 106. The data dissemination module 106 may cross reference the identifier, retrieve the associated data and forward the data to the information client interface 130. The information client interface 132, after allowing the user to verify the data, including the price, may then allow the user to initiate a commercial transaction, such as buying the product.

If the user requests to buy the product, the transaction processing module 150 may then authenticate the user by, for example, verifying the caller ID/telephone number/cell phone ID when using a cell phone, or verifying other personal data, and/or asking for the user's identifier and security code. Upon receiving the identifier from the user and verifying it using the security code, the transaction processing module 150 debits the appropriate user account and credits the seller account, e.g., owner account. This might be done by interfacing via an information client interface 132 to one or more third party systems. Appropriate verifications and transaction receipts may be sent to both parties.

Those skilled in the art will recognize that other means for collecting financial information to process the transaction using a transaction processing module may be utilized. Further, other means for authenticating the transaction may also be employed, such as contacting the buyer directly for verification, using a security code, security login or using other data for verification

F. E-Commerce Accounts

In one example of one implementation, the system may have at least 3 basic types of accounts: Customer Account, Vendor Account, and Product Account. Further, for product lines having more than one product, a Product Line Account may be set up as a type of Product Account. Customer Account, Vendor Account and Product (Product Line) Account may be associated with an identifier (ID). This identifier (ID) may be used to get information or tailored information for a particular situation such as a location, date, time, preferences, circumstances etc. by passing it to ISS 100 through for example Information Client 130 or Information Client Interface 132. Some Customer Account, Vendor Account, Product Account may not have an identifier (ID) and only have a Ref. (Reference) in the database for accessing. Data associated with these accounts may be totally or partially implemented in a database, e.g., main database module 104. This database may be a relational database. In this example, some of the Customers, Vendors and Products may have their own identifier.

1. Customer Account

Using FIG. 2 as reference, in one example of one implementation, the data provided by an information source 120 to a data collection module 102 may be data provided by a customer to create a customer account. Such an account may have the following fields:
Customer name
Customer identifier (ID)
Customer Ref.
Screen name
Password
Contact information
   Address
   Address 2
   Telephone number
   Cell phone number
   Emails
Security Information
   PIN
Financial Information
   Bank Account
   Credit Card Account
   Paypal Account
   Customer Account Processor Interface(Third party financial interface program. This is in addition or in place of dealing directly with different financial accounts)
Preferences
   Language
   Shipping address(es)
   Purchase limit (maximum $ per transaction)
Transaction history

The above is an example of one implementation of a Customer Account. Many other fields may be included or many of the current fields excluded to create such an account. Thus, a Customer Account may or may not have all the above listed fields. The information regarding this account may be partially or completely implemented in a database, such as the main database module 104. This information may be input via the Data Collection Module 102 via an information client interface 132, which may or may not be integrated into the ISS 100. In operation, a new account may be created by a customer. This information may be added/modified by customer via a website or other user interface.

2. Vendor Account

Using FIG. 2 as reference, in one example of one implementation, the data provided by an information source 120 to a data collection module 102 may be data provided by a vendor to create a vendor account. Such an account may have the following fields:
Vendor name
Vendor identifier (ID)
Vendor Ref.
Contact information
   Address
   Emails
Rating (Customer and critic rating)
   Inventory Information (Where and how the vendor inventory may be checked)
   Database/Webpage etc. location/Address
   Account/Password (Our account in their system)
   Access protocol
   Format (This is how the vendor's database/webpage etc. is formatted)
   Inventory Format
Transaction Information (How to buy/return/bid on items etc. from this vendor)
   Buy/Return interaction procedure
   Account/Password (Our account in their system)
   Verification procedures
   Transaction format and procedures (Sequence of events, procedures and information that need to be completed to finalize a transaction)
   Item information format
   Customer information format
   Other required information format
   Purchase/Return procedure
   Conformations (email etc. . . . )
   Reports
   Error handling
Financial Information (Financial Account information of the Vendor)
   Account/Password (Our account in their system or another third party system)
   Verification procedures
   Bank Account
   Credit Card Account
   Paypal Account
   Vendor Account processor interface (Vendor/Third party financial interface program. This is in addition or in place of dealing directly with different financial accounts)
Procedures/Format
Transaction history
Preferences/Settings

The above is an example of one implementation of a Vendor Account. Many other fields may be included or many of the current fields excluded to create such an account. Thus, a Vendor Account may or may not have all the above listed fields; for example, a vendor account may not have a transaction information section. The information regarding this account may be partially or completely implemented in a database, such as the main database module 104 and/or various programs. This information may be input via the data collection module 102 via an information client interface 132, which may or may not be integrated into the ISS 100. Alternatively, this information may be input automatically, semi-automatically or manually via the data collection module 102. For example, the data collection module 102 may search the web and other Third party system 160 for the new vendors and make a separate account for the new vendor and fill out part or all of the vendor information. This may be done in a regular interval or using an alert from third party system 126. In another example, all or part of the information may be entered manually.

In one example of one implementation, transaction processing module 150 may have a predefined interface and the information source interface 122 and/or information client interface 132 may seamlessly translate command/procedures etc. between a third party system/other databases (160,161) and transaction processing module 150. In another example of one implementation, transaction processing module 150 may be very flexible and capable of interfacing directly with different third party systems/DBs (160,161). In one example of such implementation, transaction processing module 150 may have parameters that allow it to be configured to interface with different third party systems/databases (160,161). These parameters may be saved in main database module 104 under different accounts (e.g. a vendor account). These are only two examples of two implementations. There are many other methods for interfacing transaction processing module 150 to third party systems/databases (160,161) that may be employed.

3. Product Account

Using FIG. 2 as reference, in one example of one implementation, the data provided by an information source 120 to a data collection module 102 may be data provided by a vendor to create a product account. Such an account may have the following fields:
Product name
Product identifier (ID)
Product Ref.
Keywords
UPC
ISBN
Description
Rating (Customer and critic rating)
Vendors (These are the vendors carrying this product)
   Vendor1 identifier (ID)/Inventory number/price/quantity in stock
   Vendor2 Ref/Inventory number/price/quantity in stock
   Vendor3 identifier (ID)/Webpage/price/quantity in stock
   Vendor4 Ref/Webpage/price/quantity in stock

The above is an example of one implementation of a Product Account. Many other fields may be included or many of the current fields excluded to create such an account. Thus, a Product Account may or may not have all the above listed fields; for example, a product account may not have a UPC or ISBN associated with it. The information regarding this account may be partially or completely implemented in a database, such as the main database module 104. This information may be input via the data collection module 102 via an information client interface 132, which may or may not be integrated into the ISS 100. Alternatively, this information may be input automatically, semi-automatically or manually via the data collection module 102. For example, the data collection module 102 may search the web and other Third party system 160 for product(s) associated with an identifier (ID) by for example looking for a description, keywords, UPC and/or ISBN etc. and make a separate account for the product and fill out part or all of the product information. This may include a list of vendors carrying the product. In this example, when a vendor carrying the product is found, the vendor as well as a pointer to the product such as an inventory number or a webpage is added to the list under the Product Account. If this is a new vendor, an account may be created for the vendor as well. The price and other information such as quantity in stock may be looked up by ISS 100 every time it is to be presented to a customer. In another example of one implantation, every time a request to access an identifier is received from a customer, all the information about the vendors carrying it is looked up in real-time. The database may be updated in a regular interval or using an alert from third party system 126. In another example, all or part of the information may be entered manually.

A list of undesirable vendors may also be used to remove or filter the corresponding information. A Product may have several different identifiers associated with it. In one example of one implementation, an identifier (ID) may be issued to a product carried by an specific vendor. In this example, the Vendor list under the Product Account has only one reference which could be the corresponding vendor.

4. Product Line Account

Using FIG. 2 as reference, in one example of one implementation, the data provided by an information source 120 to a data collection module 102 may be data provided by a vendor to create a product line account. Such an account may have the following fields:
Product ID
Description
Rating (Customer and critic/rating)
Products (List of products in this product line)
   Product1 identifier (ID)
   Product2 Ref
   Product3 identifier (ID)
Vendors (These are the vendors carrying this product)
   Vendor1 identifier (ID)/Inventory number/price/quantity in stock
   Vendor2 Ref/Inventory number/price/quantity in stock
   Vendor3 identifier (ID)/Webpage/price/quantity in stock
   Vendor4 Ref/Webpage/price/quantity in stock

The above is an example of one implementation of a Product Line Account. Many other fields may be included or many of the current fields excluded to create such an account. Thus, a Product Line Account may or may not have all the above listed fields; for example, a product line account may not have a Customer Rating associated with it. The information regarding this account may be partially or completely implemented in a database, such as the main database module 104. This information may be input via the data collection module 102 via an information client interface 132, which may or may not be integrated into the ISS 100. Alternatively, this information may be input automatically, semi-automatically or manually via the data collection module 102. For example, the data collection module 102 may search the web and other Third party system 160 for product(s) associated with an identifier (ID) by for example looking for a description, keywords, product list, UPC(s) and/or ISBN(s) etc. and make a separate account for the product and fill out part or all of the product information. This may include a list of vendors carrying the product. In this example, when a vendor carrying the product is found, the vendor as well as a pointer to the product such as an inventory number or a webpage is added to the list under the Product Account. If this is a new vendor, an account may be created for the vendor as well. The price and other information such as quantity in stock may be looked up by ISS 100 every time it is to be presented to a customer. In another example of one implantation, every time a request to access an identifier is received from a customer, all the information about the vendors carrying it is looked up in real-time. The database may be updated in a regular interval or using an alert from third party system 126. In another example, all or part of the information may be entered manually.

This is just an example; many other fields may be included or some may be excluded. Data dissemination module 106 and transaction processing module 150 may use the information in these three basic types of accounts to provide tailored information to a customer and an ability to seamlessly purchase an item among other activites. Data collection module 102 may be asked to lookup certain information such as price and number of items in stock in real-time every time such information is to be provided to a customer.

An entity may both have a customer and a vendor account thus allowing it to both sell and buy. There are some transactions that do not include product and/or monitory exchange (e.g. subscription to a news letter or giving donations).

In one example of one implementation, when a customer enters a ID+(i.e. a group identifier+Inventory number), data dissemination module 106 may use the group identifier part to lookup the corresponding vendor and the Inventory number to access specifically the information about the product associated with the inventory number and present it.

### III. Examples of ISS Implementations

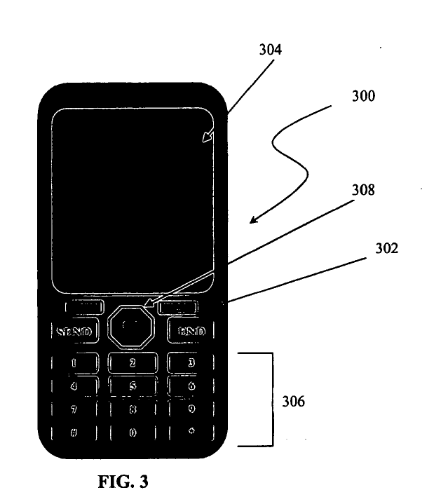

FIGS. 3 to 12 below illustrate various example of different implementation for the use of an information sharing system in connection with cellular telephones to retrieve product information and/or to facilitate commercial transactions. While the illustrated implementations are shown in connection with the use of cellular telephones, those skilled in the art will recognize that the ISS may be utilized in connection with any electronic device, including but not limited to, electronic handheld devices, such as PDA or other storage devices, computers, servers, GPS systems, navigation system, etc.

For purposes of illustration only, FIG. 3 is provided which illustrates an example of a user interface on a cellular telephone 300. In this example, the cell phone 300 has a keypad 302 and a screen 304. The keypad 302 consists of a numeric area 306, mouse key 308, SEND, END, CLR; S1 and S2 soft keys. The mouse key 308 can be pressed in four directions (up, down, left and right) and has an action “OK” key in the middle.

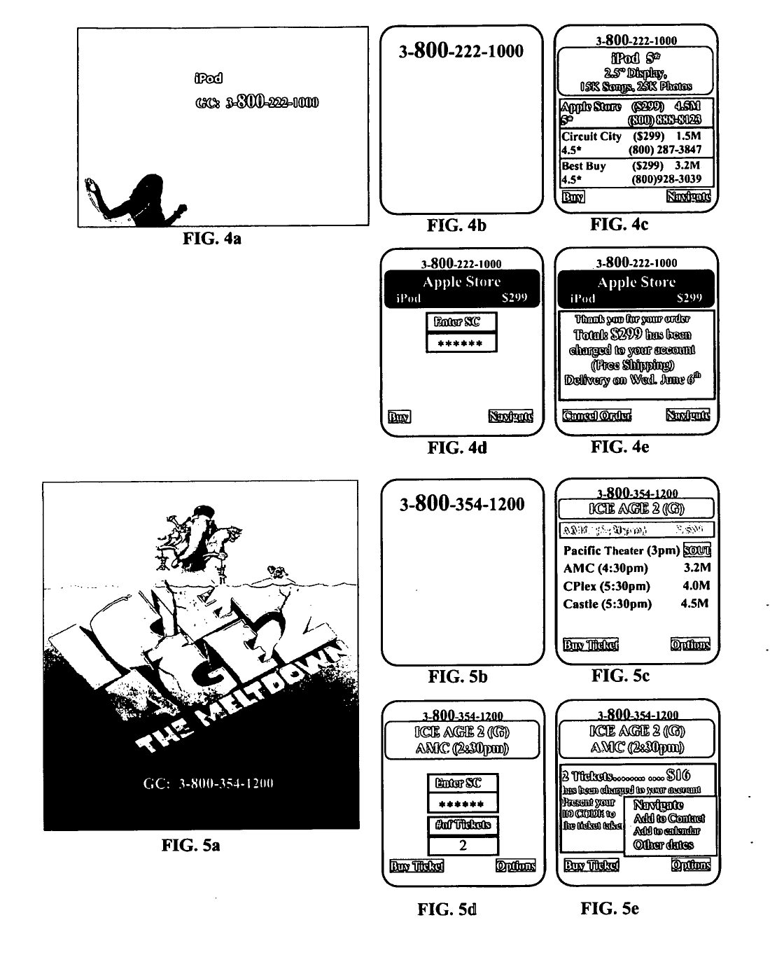

FIGS. 4 through 12 illustrate a few examples of different implementation of how identifiers can be used in connection with obtaining information regarding products and/or service and facilitating the sale of such products and services via a cell phone 300. In one example, the cell phone 300 may have the ability to communicate with a server, which may be accessible through the web.

FIGS. 4a-4c illustrates one example of one implementation of an identifier that is associated with a product. In particular, FIG. 4a illustrates one example of how an identifier for a particular product may be disseminated. In this example, an advertisement for an iPod®, which is a registered trademark of Apple Computer, Inc., includes an identifier that is displayed as “GC: 3-800-222-1000.”

FIG. 4b illustrates a screen display from the entry of an identifier associated with a product. In this example, the identifier for the iPod® is entered into the input screen 304 of the cell phone 300. When the “SEND” or “ENTER” button is pressed, the identifier, along with the location of the cell phone, may then be forwarded to the server to retrieve information associated with the identifier if the information is not available local to the cell phone. FIG. 4c illustrates one example of a screen display presenting corresponding data associated with the identifier. In this example, the product associated with the identifier is listed as an iPod® with a 2.5″ display with 15K Songs, 25K Photos. Further, the ISS 100, based upon the location of the cell phone, has identified three stores nearby that carry the iPod®, which is an Apple Store, a Circuit City and a Best Buy. Star ratings for each store (based upon user reviews), the price of the product at each store, the distance to each store and the telephone number are further displayed. Although not shown, other information may also be made available to the user. Further, the user is given the option of Buying a product at a particular location by highlighting the desired location of a product, selecting “Buy” and pressing the S1 key on the user's cell phone. Similarly, the user may generate routing information to the desired store location by highlighting the store location, selecting “navigate” and pressing the S2 key on the user's cell phone.

An entity may be given a preferred sequence placement. In this example, although stores are sorted by their distance to the user, Apple Store, which is farther away than Circuit City, is placed first. Preferred sequence placement may be provided as a service for a fee. In one example of one implementation, a store may pay a fee to be always the first on a list in a given area. In another example of one implementation, stores may bid for preferred sequence placement every time the list is generated. Further, in other example of one implementation, advertising may be inserted in the data stream. This could be random advertising or targeted advertising based on different criteria such as user preferences, location, date, time, circumstances etc. In one example of one implementation, advertisers may bid for a spot to place their adds.

FIG. 4d illustrates one example of a screen display that may be utilized if a buyer elects to purchase the product or service associated with the identifier. If the user elects the “Buy;” option, the user may be asked to enter the user's security code that releases the user's financial information, allowing for the automatic purchase of the selected product using such information. FIG. 4e illustrates one example of a screen display confirming the purchase of the product or service associated with the identifier. As illustrate, the system may also provide the user with the ability to cancel and order once placed.

FIG. 5a illustrates one example of how an identifier for a particular event may be disseminated. In this example, an advertisement for the movie “ICE AGE2, The Meltdown” is illustrated that displays an identifier “GC: 3-800-354-1200.”

FIG. 5b illustrates another example of an input screen that may be displayed on a cell phone to input an identifier. This is one example of one implementation of how multi-session event identifiers may be used in a cell phone. Multi-session event identifiers may generate information related to one entity or a collection of many entities that can be used to find the one best suited to the user. FIG. 5b illustrates a screen display from the entry of a multi-session event identifier that starts with “3-800”, which may indicate this is a multi-session event identifier When the “SEND” button is pressed, the identifier, in addition to the GPS coordinates of the cell phone and the time, if it is different than the current time, may then be forwarded to the server. The server recognizes the multi-session event identifiers and takes the current location of the cell phone user as well as the date/time into account. From there, the server can identify one or more closest session in the set and forward it to the cell phone for display. As illustrated in FIG. 5b, the cell phone may then display the name of the movie with a list of closest theaters that are showing it in the near future. In this example, the sessions are sorted chronologically.

As illustrated, in this example, the user inputs the identifier associated with the “ICE AGE2, The Meltdown” movie. When the “SEND” or “ENTER” button is pressed, the identifier, along with the location of the cell phone, may then be forwarded to the server to retrieve information associated with the identifier if the information is not available local to the cell phone.

FIG. 5c illustrates another example of a screen display presenting corresponding data associated with the identifier. As illustrated in FIG. 5c, the ISS 100 identifiers five theaters in proximity to the cell phone that are showing “ICE AGE2, The Meltdown” and the corresponding starting times for the movie at each location, along with the distance to the location. Although not shown, other information may also be made available to the user. Further, the user is given the option of buying a ticket product at a particular location by highlighting the desired location and show time, selecting “Buy Ticket” and pressing the S1 key on the user's cell phone. Similarly, the user may be able to perform additional tasks, such as generating routing information to the desired theater location, by selecting “Options” and pressing the S2 key on the user's cell phone.

In this example, the user has already setup a “Contact with Financial Account Information”. When the user selects “Buy Ticket”, the telephone number verified by caller ID/telephone number/cell phone ID may authenticate and identify the user. In turn, as illustrated in FIG. 5d, the server may request additional information, including the number of tickets needed and the user's security code. Tickets may be purchased via a secured network. The user's account is charged and the theater's account is credited with the price of the tickets and any transaction fee. In another example of one implementation, the user may have already been securely logged in and no security code is required to be entered.

FIG. 5d illustrates one example of a screen display that may be utilized if a buyer elects to purchase the product or service associated with the identifier. If the user elects the “Buy Ticket” option, the user is then asked to enter the user's security code to releases the user's financial information and allow for the automatic purchase of the selected tickets. As illustrated, it is also necessary to designate the number of desired tickets. Although not shown, the type of ticket, such as adult, child, senior citizen, may also be designated.

Since the user is purchasing tickets via a cell phone, the user is not able to print a receipt or print the tickets. To verify the transaction, a confirmation number may be sent to the user once purchased to provide to the theater. FIG. 5e illustrates one example of a screen display confirming the purchase of the product or service associated with the identifier. As illustrate, the system may also provide the user with additional options once the tickets have been purchased, such as “Navigate”, “Add to Contacts”, “Add to Calendar” or “Other Dates”. “Navigate” will calculate routing information to the theater where the user purchased tickets. “Add to Contacts” may add the theater to the user's personal contact information. “Add to Calendar” may add the time of the movie to the user's personal calendar. “Other Dates” may give the user other dates and times in which the movie is showing.

Alternatively, in another example of one implementation, the user may have a unique personalized barcode of “Receipt ID” attached to his cell phone. These barcodes may be distributed by an organization so each individual would receive a unique barcode. The user may register the barcode number on his/her account, which then could be used as a “Receipt ID” for different transactions. The transaction is referenced to the user's “Receipt ID”. The ticket-taker at the movie theater has a barcode reader that has access to the transaction. The user simply presents the “Receipt ID” barcode to the ticket-taker. The ticket-taker device following reading the barcode, indicates if there are any tickets (including the number) waiting for the owner of the “Receipt ID”. In another alternative example of one implementation, the receipt barcode could be rendered on the display of the cell phone, which could be recalled and scanned (e.g., by a ticket taker). There are many other methods that can be used in place of barcode including but not limited to RFID, smartcards etc. to authenticate a transaction in the form of a receipt.

In a further example, each party to the transaction may receive a conformation from transaction processing module 150. Conformation may take many different forms, including, but not limited to, a number or a code, which may be used by the parties for referencing, proof of transaction, and/or receipt among others thing. One of user's or buyer's ID may also be used in place of or in addition to other type of conformations. The conformation may also be in form of an equation which will be used to authenticate a device. The equation may be used by a device such as a cell phone as a pass.

In this example, the user may also use the cell phone as a receipt. The ticket-taker at the movie theater may have a device that may interface to the cell phone by variety of short range communication medium (e.g. IR; Bluetooth etc.). A session between the ticket-taker device and the user's cell phone may be initiated by either device. Following authentication, the cell phone presents the receipt for the transaction to the ticket-taker device. The receipt may be presented and verified via many different techniques. In one example, the cell phone simply provides the confirmation number or an encrypted version. In another example implementation, the receipt is in form of an equation that is provided to the cell phone at the time of purchase. The ticket-taker device provides the cell phone with input; the cell phone runs the equation on the input and provides the result back to the ticket-taker device. The ticket-taker device compares the output with its own calculations run on the same equation (the equation is provided by the server), and if they are matched, informs the ticket-taker. The ticket-taker device then cancels the tickets. This technique may be used regardless of how the session has been initiated.
Further, as illustrated in FIG. 5c, the user may be given the option of adding the movie theater to the user's contact database by selecting “Add to Contact”. By choosing “Add to calendar”, the time period highlighted may be added to the calendar. This may also include the name and address for the movie theater. Other options such as watching the trailer, getting more details and looking for showing time in different dates and time will be provided to the user. In this example, the user may pick one the movie theaters using the mouse button and presses “OK”. The corresponding address may be sent to a navigation program that plots a course from the current position. In yet another example of one implementation, the identifier may belong to a movie theater. In other examples of one implementation, the identifier may belong to a movie theater or a movie playing at a movie theater. An entity such as a movie may be identified by many different identifiers from different points of view. For example, if the user enters an identifier that belongs to a movie theater, a list of movies playing in that theater may be presented to the user including playing times. The user may be given the choice to pick a movie and buy tickets for the movie. In another example of one implementation, a movie playing in a particular movie theater has a unique identifier. Patrons may use their cell phone to easily and quickly buy the tickets by entering the code rather than standing in line.

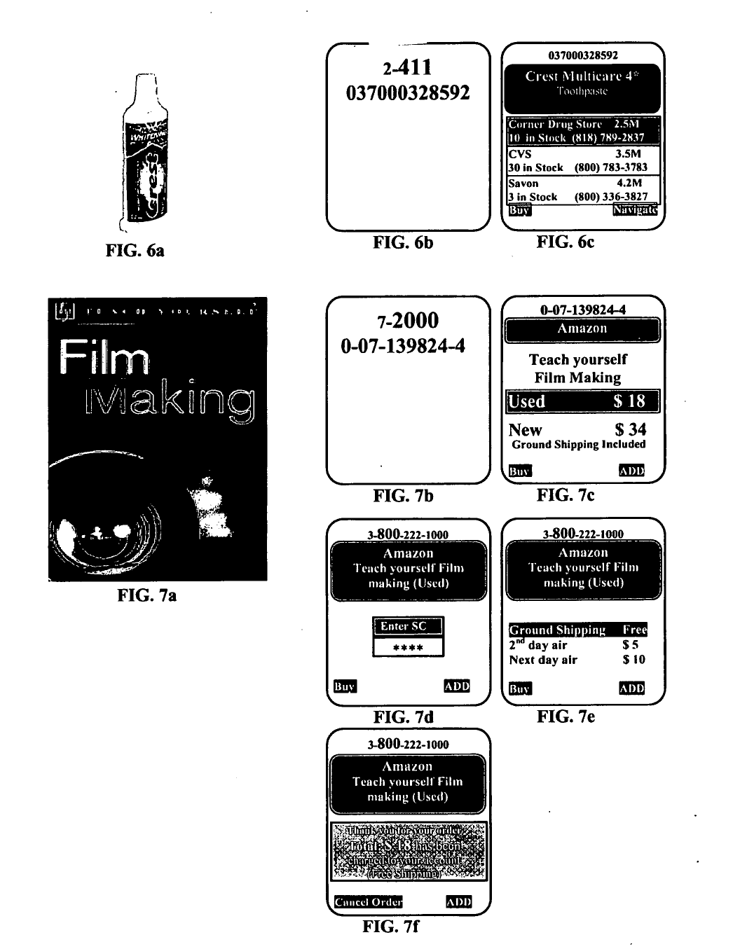

FIG. 6a illustrates another example of how an identifier for a particular product may be obtained. In this case, the UPC located on the back of the product, which in this example is Crest toothpaste, may be used to construct part of a product identifier. Many retailers usually use this number for checkout. FIG. 6b illustrates another example input screen that may be displayed on a cell phone to input an identifier. In this example, the series of number “2-4111-037000328592” is input into the screen. The prefix 2-411 may be used to alert the system that a UPC/ISBN etc. or other types of product code is being entered into the system, which is represented, in this example, by 037000328592.″ In this example, the prefix “2-411” may notify the system that the user is looking for all available manufacturers and retailers that offer the product, associated with the UPC.

Using the UPC product code, the ISS is able to locate the nearest stores to the cell phone user that carry the Crest toothpaste. After the user enters the identifier and the “SEND” or “ENTER” button is pressed, the identifier, along with the location of the cell phone, may then be forwarded to the server to retrieve information associated with the identifier if the information is not available local to the cell phone. The server searches the main database module 104 as well as all accessible third party databases 160 to find retailers that carry this product. FIG. 6b illustrates one example of a screen display that shows the result of this search.

FIG. 6c illustrates yet another example of a screen display presenting corresponding data associated with the identifier. In this instance, the three locations nearest the cell phone user that carries the Crest tooth paste are returned to the user, along with distance to the stores, the numbers to the stores and the number of items in stock at each location.

Those skilled in the art will recognize that other universally recognizable numbering systems, such as ISBN, may also be used in addition, or alternatively, to a universal product number. In one example of one implementation, when a universal product number or ISBN is added following a companies identifier, the system will check specifically to find out if that particular company carries the product and present the result to the user with appropriate options. The result may include closest branches of the company to the user, contact information, distance, number of units in stock, price of units and if the product is available online. In this example, if the company has already been saved into contact, it can be picked up from the contact list and additional numbers representing different product added. There is no need to reenter the company's identifier. In this embodiment, in any application discussed in this document, an entity may be picked up from the contact manager or scheduler without the need to reenter the identifier. The user may then have the option of adding other sequences or use the stored identifier. An identifier may, however, be reentered at any time.

In summary, in this example, it is illustrated that a code, such as a bar code, ISBN or UPC is input, the data collection module 102 finds all the vendors for the product. In one example of one implementation, Data collection module 102 may do this real-time every time a request is received or offline storing the result in the database or a combination of the two, e.g., vendors of the product is identified and tabulated offline but the price, availability and number of units in stock are gathered real-time every time a requests comes in. Vendors included in the search may be automatically identified by searching the Internet, manually included or excluded.

In one example of one implementation, in case of commonly used identifiers such as ISBN and UPC, the description may be gathered automatically by the data collection module 102 offline or on real-time which in turn may be used to access information from vendors. Alternatively, in another example of one implementation, ISBN or UPC etc. can be used to locate the item if they are available in the vendor's database. In either case, ISS 100 identifies the ISBN or UPC etc. format and process it accordingly. UPC or ISBN may be read automatically using a barcode reader or a barcode reader program and the camera in a cell phone.

FIG. 7a illustrates yet another example of how an identifier for a particular product may be obtained. In this example, a film making book is displayed. The ISBN located on the back of the book product, which in this example is a book titled Teach Yourself Film Making, may be used to construct part of a product identifier. FIG. 7b illustrates another example input screen that may be displayed on a cell phone to input a company identifier along with a product identifier. In this example, the series of number “7-2000-0-07-139824-4” is input into the screen. The prefix 7-2000” may be used to represent a company in which the user would like to determine has the particular book. In this case, “7-2000” may represent a short form identifier for Amazon.com. After the Amazon.com is entered into the system, the ISBN product code is entered; which is represented, in this example, by “0-07-1398244.”

FIG. 7c illustrates one example of a screen display presenting the corresponding data associated with the identifier. In this example, the system is able to retrieve, either locally or via a server, information that Amazon has both used and new copies of the book. The user is given the option to select the new or used book and buy the book buy selecting “Buy” and pressing S1 on the user's phone. Alternatively, the user may select “Add” by pressing the S2 key on the cell phone, which will add the information relative to Amazon and/or the book in the user's contact list.

FIG. 7d illustrates another example of a screen display that may be utilized if a buyer elects to purchase the product or service associated with the identifier. If the user elects the “Buy” option, the user may be asked to enter the user's security code to release the user's financial information and allow for the automatic purchase of the selected book. FIG. 7e illustrates one example of a screen display presenting shipping options for the purchase of a particular product. In this case, the user may select to have the book shipped ground, 2^{nd} day air, next day air, etc.

Once the user selects the shipping option, the user presses “Buy” on the cell phone using the S1 key. Order confirmation may be then presented to the user, which may include an option to cancel the order. FIG. 7f illustrates one example of a screen display presenting order confirmation information.

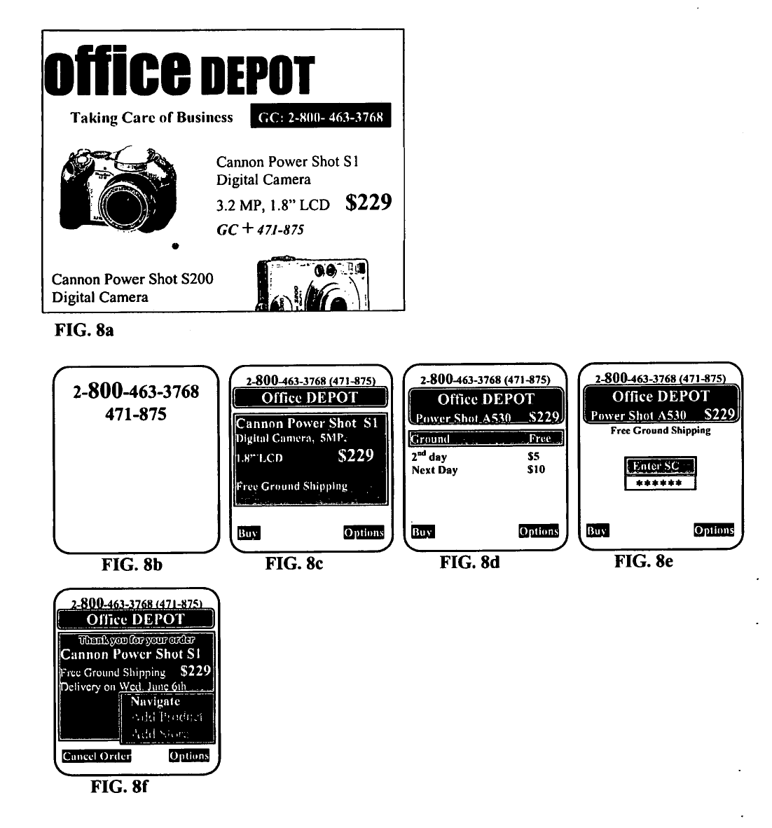

FIG. 8a illustrates still another example of how an identifier for a particular product may be disseminated along with a group identifier for a particular company. In this example, Office Depot is advertising a Cannon Power Shot S1 Digital Camera. In this advertisement, Office Depot is advertising a group identifier for Office Depot, which is “2-800-463-3768”, as well as a product identifier for the Cannon Power Shot, which is “471-875.” In this example, the product identifier assigned to the Cannon Power Shot is unique to Office Depot (e.g. Office Depot inventory number). Information about this product may only be retrieved when used in combination with the Office Depot group identifier. Further, the retrieved information will only related to the product as it is sold in Office Depot stores.

FIG. 8b illustrates another example input screen that may be displayed on a cell phone to input a group identifier along with a product identifier. In the example, the group identifier for Office Depot of “2-800463-3768” is entered into the screen followed by the Office Depot product identifier (or stock number) for the Cannon Power shot S1, which is “471-875.” When the “SEND” or “Enter” button is pressed after the entry of the identifier into the system, the identifier may then be forwarded to the ISS 100 server to retrieve information associated with the identifier if the information is not available local to the cell phone. In this example, when the combination of numbers are sent to ISS 100, information about the company and the product is constructed from the data available in the main database module 104 as well the Office Depot servers via data collection module 102.

FIG. 8c illustrates a screen display presenting the retrieved information to the user. The user is given the option of buying this product using the transaction processing module 150 by pressing S1 or finding the nearby locations of Office Depot®. In this example, information regarding the Cannon Power Shot S1 is displayed, which, in this example, includes price and shipping information. The user is given the option to “Buy” the product by pressing S1 on the user's cell phone or the option to view additional information and perform additional tasks by pressing S2 on the user's cell phone, which is the “Options” selection.

FIG. 8d illustrates another example of a screen display presenting shipping options for the purchase of a particular product. In this example, if the user may be able to view shipping options by either selecting “Buy” or viewing shipping options as a selection under the “Options' menu. Pricing for the various shipping options may also be provided, as illustrated in FIG. 8d.

FIG. 8e illustrates another example of a screen display that may be utilized if a buyer elects to purchase the product associated with the identifier. If the user elects the “Buy” option, the user may be asked to enter the user's security code to releases the user's financial information and allow for the automatic purchase of the selected product.

If the user chooses to buy a product, the transaction processing module 150 may then charge the user's account, credit Office Depot's account, provide Office Depot with contact information for the user including shipping address, logs the transaction and sends appropriate notification to both parties. In one example, the user may cancel the order by inputting the same sequence of numbers and this time choose cancel or return option. In this example, if Office Depot is already in the contact manager, a user may just pick the company from the list and add the stock number to retrieve the desired information.

FIG. 8f illustrates another example of a screen display presenting order confirmation information. As illustrates, along with the purchase confirmation, the system may also provide the user with additional options once the product has been purchased, such as “Navigate”, “Add Product” or “Add Store.” “Navigate” will calculate routing information to the store where the user purchased the product. “Add Product” may add information to a users data regarding the product. For example, product information may be saved in connection with the user's favorites list to allow the user to easily find the product and purchase it later, if desired. “Add Store” may add the store information where the product was purchased to the user's personal contact information.

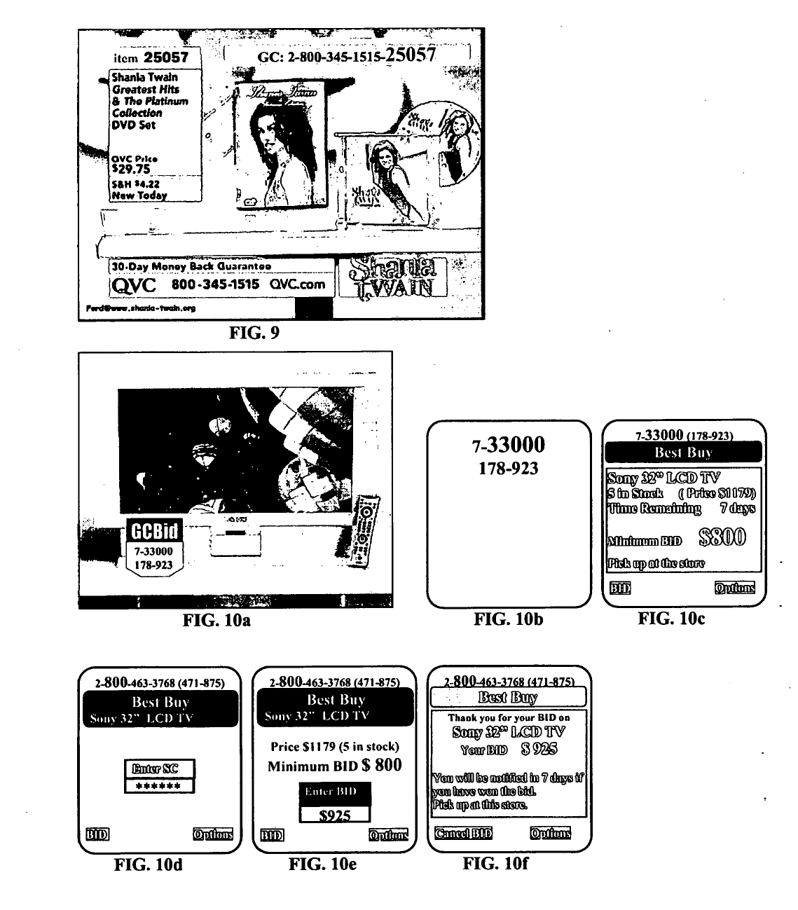

FIG. 9 illustrates another example of how an identifier associated with a particular product may be disseminated. In this example, a television program may advertise the sale of a particular product, which in this example, is Shania Twains greatest hits. Along with the advisement, the identifier for the company selling the product may be display along with the product identifier assigned to that product by the company. In this example, the identifier for QVC™ is “2-800-345-1515” and the product identifier for the album is “25057.”

FIG. 10a illustrates another example of how an identifier may be utilized to institute bidding on a product. In this example, a product that is in a brick and mortar store, in an advertisement or displayed visually elsewhere, such as on the web, newspaper, television or on radio etc. may include an identification bidding number. The fact that the identifier is associated with a bidding process may be indicated by, for example, preceding the number with the word “Bid” or other similar indicator. Alternatively, the number could contain characters that will alert individuals to the fact that the identifier is a bidding identifier.

FIG. 10b illustrates another example input screen that may be displayed on a cell phone to input an identifier. In this case, the first digits “7-3300” may either be associated with the company offering the product for sale via a bidding process or the numbers may be representative of a certain type of bidding process. When the user enters these numbers in their cell phone and presses “SEND”—or “ENTER”, information associated with this product and the bidding process may be retrieve via an ISS server if the information is not available locally.

FIG. 10c illustrates another example of the screen display presenting corresponding data associated with the identifier. In this example, it is shown that the product is being offered for sale via a bidding processing by Best Buy. Best Buy is giving the users, in this example, 7 days to bid and is offering 5 products for sale via a bid. The minimum bid is set at $800 and it is required that the product be picked up at the store. If a user would like to bid on the product, the user may select the “Bid” option by pressing S1 on the user's cell phone. If the user desires more information or to perform additional activities, the user may select “Options” by pressing S2 on the users cell phone.

FIG. 10d illustrates one example of a screen display that may be utilized to initiate bidding on a product. If the user selects the “Bid” option, the user may then be directed to an input screen to initiate bidding. To initiate bidding, the user may first be asked to enter his or her security code to authenticate the user and to retrieve associate financial data should the user win the bid.

FIG. 10e illustrates one example of a screen display that may be presented to allow the user to enter a bid for a particular product. Here, the user is asked to enter his or her bid for the product. Once entered, the user may select “Bid” to enter the bid. Once the bid is entered, the user may receive confirmation of receipt of the bid, which may include information regarding how the user will be notified if he or she entered a winning bid. FIG. 10f illustrates one example of screen display confirming the receipt of a bid for a particular product.

The type of auction that is described above is connection with FIGS. 10a-10f is a Blind Bid. In connection with the example illustrated in FIGS. 10a-10f, those skilled in the art will recognize that there are many different types of auctioning and bidding that the ISS 100 system may utilize to facilitate bidding on particular products and/or services. For example, service are available, such as those services offer by xcAuction (www.xcauction.com/UFAuctionTypes.asp), that will assist companies and individuals with implementing auctions for the purposes of facilitating on-line bidding for the purchase of products and/or services. Several other types of auction techniques that may be utilized in connection with bidding on products and/or services are explained briefly below, some of which are common bidding techniques and some of which are not currently utilized, but may be utilized in the future.

1. Open Bidding/Auction

An open bidding auction may be used in which buyers bid against each other. In this type of auction, the bidders are informed of the other's bids and the bidders can manually enter a higher bid or, enter a higher bid by setting a maximum bid to be placed on their behalf until the bidding is over. Upon the conclusion of the bidding process, the transaction processing module 150, may process the bid, by for example, transferring money from the bidder's account to the vendor's account. Further, the appropriate notifications and information are sent to the vendor and the winner of the bidding. Additionally, information regarding the bidding process, outcome and financial transaction may be exchanged between the vendor and the bidder.

2. Blind Bidding/Auction

Further, a blind bidding/auction may be utilized. In a blind bidding/auction, a user bids for an item without knowing what others are bidding for the same product. At the end of the bidding period, the item(s) will be sold to the highest bidder(s). So, for example, if there are three items available, they may be awarded to the three highest bidders. In this case, all the other bidders may be informed that they did not win the bid and may, optionally, also be informed of the winning prices. The transaction processing module 150, processes the three, highest bids by, for example, transferring money from the bidders' account to the vendor's account and sending the appropriate notifications and information to the vendor and the winners of the bidding. Additionally, information regarding the bidding process, outcome and financial transaction may be exchanged between the vendor and the bidder.

3. Reverse Auction

Similarly, a reverse auction may be utilized. One this example, when a bidder enters an identifier associated with a product, a description of the product and the number of the items left and perhaps the retail price may be provided, as well as a starting maximum bidding amount and remaining bidding period. The bid amount decreases as time elapses until someone buy the product. A bidder may watch the auction real-time and press a button to buy a product or enter an advance bid. The bidder may also set an alarm to inform them when the buy amount is less than a given amount. The auction stops when there are no more items left, when the price is lower than what the auctioneer set as the minimum bid or when the auction is terminated by the auctioneer. The auctioneer may setup the auction through the ISS 100 directly either manually or automatically. Upon the conclusion of the bidding, the transaction processing module 150 processes the bid by, for example, transferring money from the bidder's account to the vendor's account and sending the appropriate notifications and information to the vendor and the winner of the bidding. Additionally, information regarding the bidding process, outcome and financial transaction may be exchanged between the vendor and the bidder.

4. Other types of Auctions

Other types of auction such as Dutch auction may also be used in conjunction with the identifiers. Another example is an exclusive auction that is only open to individuals that have a security code. To access this type of auction, in addition to an identifier, a security code extension to the identifier is also required to be entered to be able to view and further bid on the item. Another example is an auction that only the registered bidders may access.

5. Combination Auction

A combination auction may be utilized for bidding on both single and multiple items. A combination auction may be an auction that utilizes various principles of the auction types described herein, including other auction types. For example, an auction may start with open bid and after the first product is sold utilize a blind bid to sell remaining products. Alternatively, an auction may start with a blind bid and after the first product is sold utilize an open bidding processing to sell remaining products. Further, an auction may start with a reverse auction and move to either an open bid auction or a blind bid auction after the first unit of product is sold. Although the above example describe using two bidding processes together, three or more bidding processes may be used. For example, an auction may start with a reverse auction, move to open bid after the first product is sold then move to blind bid. These types of auctions may be alternated or combined in any fashion to sell a number of products.

6. Fuzzy Auction Duration

Because people tend to wait until the last moment to bid on products when they are on auction for a specified duration of time, auctions of this nature can sometimes be ineffective. People simply wait until the last moment to bid and try to win the product by penny increments. One solution would be not to announce the exact ending time of the auction and instead give a range, e.g., the auction may end anytime Wednesday the 3rd between 9 am to 6 pm. The uncertainty will engage the bidders at least between 9 am till 6 pm on that Wednesday. The actual ending time may be set, randomly, by the ISS 100 system administrator, by the auctioneer, based on an algorithm or via another other method for establishing a time to end an auction.

7. Ending by Possession

Yet another way to get bidders involved prior to the last seconds of the bidding period would be to conclude the bidding if a specific bidder holds a bid a specified time period. This time period may be displayed in a reverse clock format. This type of auction may be termed, ending by possession. The reverse clock may start at the end of the bid, from the beginning of the bid, at a certain time, for example, so many hours before the end of the bid, at a certain bid amount, which may be set by the auctioneer, randomly, or any other method for timing out a bid, including any combination of the foregoing. In this example bidding process, bidders may choose to be notified when ending by possession bidding is initiated or when it reaches a certain number of minutes till someone wins by possession. Ending by possession may act alone or in conjunction with other criteria to end an auction, such as an end time.

In the same manner that auctions may be used for consumers, as described above, vendor auctions may be performed by the ISS 100. In this regard, a buyer may ask for vendors to bid on different products and our services to be provided to the buyer, such as hotel accommodations, flights, loan rates and closing costs, insurance, and etc. using an identifier. In this example, the identifier may be associated with an ISBN or UPC when bidding is to occur on a particular product. Like customers, the vendors may use open or blind bidding procedures, in which case the smaller bid wins the business. Information is then exchanged between the consumer and the vendor when the winning bid is awarded. A reverse auction may also be used for vendor bidding. In this case, the amount starts with zero and as time elapses the bid increases. The first vendor to accept the price wins the bid. Further, the ISS 100 may allow venders to automatically bid on different items, which may include shipping charges to give a local vendor an advantage. Additionally, customers may require bids from venders that meet certain criteria, such as having a minimum customer rating or having been in business for a certain time period, among other criteria. Registered vendors may automatically become involved in an auction utilizing a preset bid or may manually participate in the bidding process. When initiation a bid, a customer may also enter a price or enter a maximum price. Vendors, in turn, may also rank the customers.

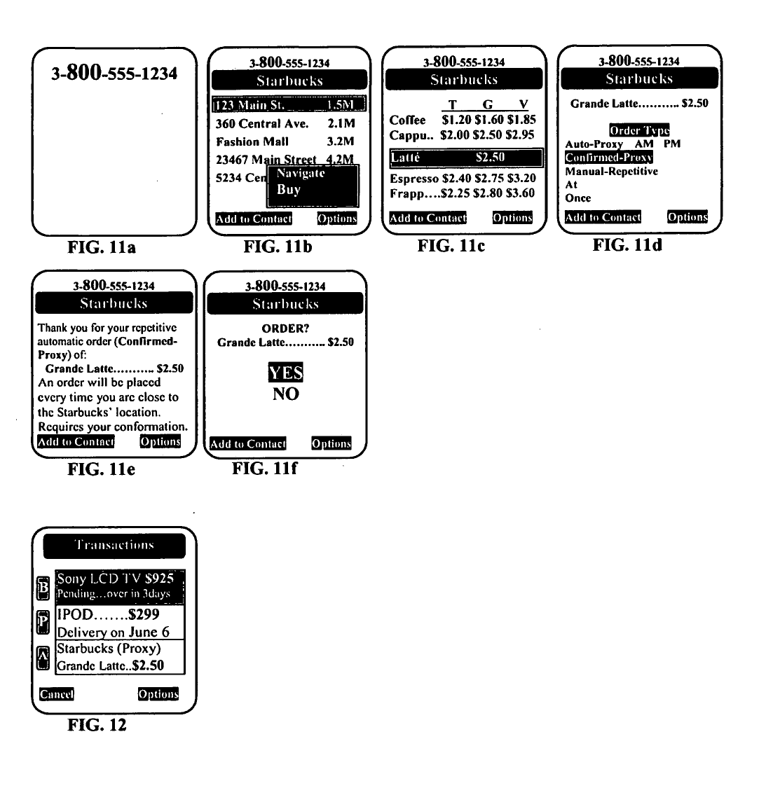

Turning now to FIG. 11, FIG. 11a illustrates another example input screen that may be displayed on a cell phone to input a group identifier. In this example, a group identifier for Starbucks is entered into the input screen. When the “Send” or “Enter” key is pressed on the cell phone, information associated with the identifier is retrieved from the ISS server if not available locally. Further, information regarding the location of the cell phone may also be send to the server to assist with calculating the nearest Starbucks locations. FIG. 11b illustrates another example of the screen display presenting corresponding data associated with the identifier. In this example, the five Starbucks nearest the cell phone user is displayed, along with the option to add the contacting information for any of the listed Starbucks to the users personal contact database. The option of generating routing information to any of the listed Starbucks is also provided along with the option of buying product from a particular store.

FIG. 11c illustrates one example of a screen display showing product available for purchase and the prices associated with the product. In this example, the user in FIG. 11b selected the option to “Buy” product from a particular Starbucks by highlighting the desired stored and selecting the “Buy” option. As seen in FIG. 11c, a list of product available at the selected location, along with the prices of each product are displayed in manner that allows the user to highlight and select the desired product for purchase. Once the product is selected, the user may then be given the option of placing various order types, such as “Auto-Proxy”, “Confirmed-Proxy”, “Manual-Repetitive”, “At” and “Once”. FIG. 11d illustrates one example of a screen display that may be presented to a user to allow a user to purchase a particular product by placing different order types. In this example, the “Auto-Proxy” selection allows the user to place an order automatically when the cell phone is within a certain distance from the location. The “Confirmed-Proxy” selection presents the user with the option to buy a pre-selected type of product when the user is within a certain distance from the location The “Manual” selection allows the user to save a particular order and recall the order whenever the user desires to purchase the product. The “At” selection allows the user to purchase at a particular time and the “once” selection allows the user to place a one-time order without saving an of the order information for use in the future.

FIG. 11e illustrates one example of a screen display providing confirmation information for the recording of a “Confirmed-Proxy” order. As illustrated, if the user elects to have a Grand Latte order placed using a “Confirmed-Proxy”, the user will be asked, via a cell phone display, whether the user desire to place an order for a Grand Latte whenever the user is close to the selected Starbucks location.

FIG. 11f illustrates one example of a screen display that may be automatically displayed to determine whether a user desires to order a particular product when a user approaches a store that sells such product. Here, the user, having placed a “Confirmed-Proxy” order, has traveled in the vicinity of the selected Starbuck's location and is being asked whether the user desires to place an order for a Grande Latte by selecting “Yes” or “No.” If the user does not respond, the system can assume that the user does not desire to place an order at that time.

FIG. 12 illustrates one example of a screen display presenting a list of recent transactions to a user. In this example, the user is able to determine that the user has three recent transactions. A transaction proceeded by a “B” may indicate that a user has placed a bid for a product. A transaction proceeded by a “P” may indicate that a user has purchased a particular product. A transaction proceeded by a “A” may indicate that a user has established an “Auto-Proxy” purchase transaction, as described in connection with FIG. 11d above. As illustrated, the user has placed a bid for a Sony TV, has purchased an iPod® and has an “Auto-Proxy” for Starbucks.

In general, an identifier may belong to a seller that has many products for sale. The buyer may, by inputting the associated identifier, get a list of products for sale by the seller. By scrolling and picking one of the products, a purchase sequence may be initiated. Other examples of products that may be sold and purchased include admission tickets to theaters, movies, concerts, sporting events among others. Further, donations may be made by a user by entering an identifier for an organization, entering security code and/or security code and entering an amount. In this example, there is money paid by a user to an organization with no exchange of product only a receipt may be received. In another example of one implementation there could be no monitory exchange but rather information exchange and agreement, for example, for a service. For example, a user may subscribe to a free newspaper subscription by entering the identifier for the newspaper and indicating the desire to receive it. After authenticating the user, the transaction processing module 150 may pass the appropriate user's information such as name, address, telephone number etc. to the newspaper, gets appropriate conformations, updates accounts/logs and sends appropriate notifications to both the user and the newspaper. Canceling a subscription may be just as easy. The process starts with entering the identifier by the user and requesting the subscription to be stopped. In case there is a change of address, the newspaper may get the address update automatically or the user may let the news paper know by simply entering the number. Update information also may be also allow a user to change the credit card used for monthly subscription into an account that would eliminate the need the time consuming task of updating information with different entities. Another example of one implementation is registration for getting automatic periodic emails from an entity using an identifier.

While all of the above examples illustrate the manual entry of an identifier on a cell phone, website or navigation system, an identifier or a bar code may be automatically obtained by a system using different methods. Such automatic methods may include, but not be limited to, barcode readers, radio frequency identification (“RFID”) readers, card readers, cameras (including cell phone cameras) and etc. For example, a barcode may be included on a product that is associated with an identifier. This barcode may be read by a barcode reader and transformed to a number that is representative of an identifier. Additionally, ISBN and UPC bar codes are other examples of entities that may be entered into the device automatically rather than manually through a keypad. An RFID may also be used to convey the corresponding identifier. A camera, e.g., camera on a mobile phone may be used as a front-end for capturing bar codes and identifiers.

In another example of one implementation, a camera, e.g., camera on a mobile phone, may take a picture of the business card. The picture of the business card may be run through an Optical Character Recognition (“OCR”) and an Identifier Recognition Module (IRM) to look for a corresponding identifier. This corresponding identifier may be used in place of manual entry. An IRM is a module that recognizes a series of characters that potentially could be an identifier, isolates it from other characters that might be present. Further, IRM may also pass the recognized identifier to other programs or may simulate a manual entry into another program among other functions. In one example, the OCR/IRM may be running locally, e.g., in a computer connected to a card reader, a cell phone or a PDA with an integrated camera. In this example, the camera and the scanner are virtually doing the same thing, which is grabbing the picture of the card. Alternatively, in another example of another implementation, the OCR/IRM may be running off-board on a remote server such as ISS 100. In this case, the photo will be sent to the server.

In one example of one implementation although not necessary, to simplify identification of an identifier and increase accuracy, a certain font may be recommended to be used to display identifiers and/or a certain characters such as “GC” may be added in a location proximate to the identifier, e.g., GC 9-310-888-8888. By using a certain font or having certain characters near the identifier or other distinguishing factors such as color etc., the program that looks for the identifier (e.g. IRM) may be assisted with locating and reading the identifier. The number of characters in an identifier, the grouping of the identifier and other characteristics may also be used to identify and distinguish the code from other types of information. The program that looks for the identifier (e.g. IRM) may be integrated into the OCR or run separately after the characters on the picture are identified. In this example, IRM may go through the string of characters identified by the OCR looking for numbers in a certain font, numbers that are grouped in a specific way, or numbers that are preceded by “GC”, for example. In one example of one implementation, when the program used to identify the characters that are representative of the identifier (e.g. IRM) is integrated with the OCR, they may work cooperatively so that OCR would not be required to try to recognize the characters that do not fit the criteria (e.g. other characters in the picture that do not represent an identifier). This may increase the overall efficiency of the identification process.

In one example of one implementation, when a series of characters are identified that appear to represent an identifier, the identifier may be checked against a database to determine if the identifier is a valid identifier before retrieving associated data or presenting the identifier to the user for review. It may be desirable, in certain instances, to present the identifier to the user for verification.

There are many other ways of automatically inputting an identifier or a code methods for which are known at this time or will be available in the future. It is intended that all such additional methods be included within this description, be within the scope of the invention, and be protected by the accompanying claims.

In one example of one implementation, the system may be setup such that every photo taken is automatically ran through the OCR/IRM and if a valid identifier is found, it will be processed as if the user had entered it manually. The level of automation and assumptions may be set by the user through options.

In another example of one implementation, a poster for an event, e.g., a concert, sports game or movie, may have a corresponding identifier. This identifier may be printed on the poster, a sticker on the poster, or posted in the vicinity of the poster using a separate label. A user can then enter the identifier into his or her cell phone manually using a keypad or using the mobile camera to capture a picture of the poster that can then be run through an OCR/IRM and once the identifier is located, it may be automatically entered into the user's cell phone.

In one embodiment, user feedback and statistics may also be incorporated as part of the ISS 100. When a user buys a product, they can rate the product and/or vendor. This information is gathered by ISS 100 and presented to other users in verity of manners and formats such as star system. This star system may apply to a vendor, a product, or a customer etc. In addition, statistics such as the number of returns may also be gathered and provided to the users. This could be vendor specific returns, product specific returns or a combination. Statistics may also include the number of products sold by all vendors or by specific vendors.

In one example, only vendors with certain ratings may be provided to a user. Additionally, vendors may be filtered and sorted based upon buyer ratings or upon parameters set by a buyers. Parameters that may influence the sorting and filtering of vendors may include, location, date, time, performance of the vendor, radius of search, availability, price, conflict with other schedules, vendor time in business, membership time, etc.

In summary, the invention may be implemented in a number of different implementations include a number of different modules and interfaces, permitting the interfacing to various databases, applications and with users of the ISS 100. Any implementation is within the scope of this invention if it allows one or more databases to be populated with specific data regarding individuals, companies and professional and consumer products and services, allows a second party to retrieve information using an identifier associated with such data and allows the processing of a commercial transaction based upon such data.

As illustrated above, by a few examples of various implementations, a user may utilize an identifier to perform a number of functions, including, but not limited to, processing information, formatting information, storing information, manipulating information, initiating commercial transaction, etc.

In general, each identifier may have a type associated with it. Persons skilled in the art will understand and appreciate that the data structures outlined here are for presentation and reference only. Many other data structures are possible and well understood. In one example of one implementation, an entities identifier may be the telephone number for the entity plus an additional or alternate character. For example, a company having a 1-800-555-1234 may have 2-800-555-1234 Identifier. This will make the numbers mutually exclusive but at the same time make it easy to remember and reduces the number of numbers to remember. Further, the identifiers may include a character or number that identifies whether the number is associated with a product, and event, personal information, etc.

Although not described in detail above, those skilled in the art will recognize a number of various applications and various functionalities that would fall within the scope of the invention. Information can be retrieved or input in one language and made available in a variety of different languages. In this case, a user may have the option of setting up a preferred language. Regardless of how the information was input, the information would be retrieved in the preferred language. Further, the system may provider for prices to be translated in other currencies and presented to a user in a preferred currency. Additionally, an identifier (ID) may be associated with a product that is being auctioned (again, it can a combination of IDs “vender identifier+stock number”). For example, when the number is entered, description of the product, current bid and time left is displayed. The user may enter a bid. The user will be notified if there is higher bid and when the auction is over. The transaction processor may conduct the auction by itself or it may be a front for a third party server. Additionally, ISBN and universal product numbers may be used as IDs without any other number. Further, although only a limited number of commercial transactions are illustrated in this application, any number or type of commercial transactions can be performed using an identifier. In summary, an identifier can be associated with a variety of type of information that can be used for the purpose of exchanging data, obtaining data, providing data to another or to process a transaction, such as a commercial transaction.

ISS identifiers may be used to retrieve any type of information or data in an electronic format for subsequent use by a user or a user application that would generally need to be manually input into an application for use. Each of these various systems or software programs may be considered a separate component or module of a larger system. For example, one component may provide for the receipt of an identifier and may process the identifier or associate the identifier with data requested by or required by another component of the system.

Further, the examples illustrated in FIGS. 4-12 are only several examples taken from a large number of examples of how the invention may operate. Thus, the ordering and number of steps illustrated are not required to complete the transactions described. Steps may be performed in different manners, other steps may be added, deleted, combined, altered and/or performed in a different order.

Persons skilled in the art will understand and appreciate, that one or more processes, sub-processes, or process steps described in connection with FIGS. 1 through 12 may be performed by hardware and/or software. Additionally, an ISS system may be implemented completely in software that would be executed within a processor or plurality of processor in a networked environment. Examples of a processor include but are not limited to microprocessor, general purpose processor, combination of processors, DSP, any logic or decision processing unit regardless of method of operation, instructions execution/system/apparatus/device and/or ASIC. If the process is performed by software, the software may reside in software memory (not shown) in the device used to execute the software. The software in software memory may include an ordered listing of executable instructions for implementing logical functions (i.e., “logic” that may be implemented either in digital form such as digital circuitry or source code or optical circuitry or chemical or biochemical in analog form such as analog circuitry or an analog source such an analog electrical, sound or video signal), and may selectively be embodied in any signal-bearing (such as a machine-readable and/or computer-readable) medium for use by or in connection with an instruction execution system, apparatus, or device, such as a computer-based system, processor-containing system, or other system that may selectively fetch the instructions from the instruction execution system, apparatus, or device and execute the instructions. In the context of this document, a “machine-readable medium,” “computer-readable medium,” and/or “signal-bearing medium” (herein known as a “signal-bearing medium”) is any means that may contain, store, communicate, propagate, or transport the program for use by or in connection with the instruction execution system, apparatus, or device. The signal-bearing medium may selectively be, for example but not limited to, an electronic, magnetic, optical, electromagnetic, infrared, or semiconductor system, apparatus, device, air, water, or propagation medium. More specific examples, but nonetheless a non-exhaustive list, of computer-readable media would include the following: an electrical connection (electronic) having one or more wires; a portable computer diskette (magnetic); a RAM (electronic); a read-only memory “ROM” (electronic); an erasable programmable read-only memory (EPROM or Flash memory) (electronic); an optical fiber (optical); and a portable compact disc read-only memory “CDROM” “DVD” (optical). Note that the computer-readable medium may even be paper or another suitable medium upon which the program is printed, as the program can be electronically captured, via, for instance, optical scanning of the paper or other medium, then compiled, interpreted or otherwise processed in a suitable manner if necessary, and then stored in a computer memory. Additionally, it is appreciated by those skilled in the art that a signal-bearing medium may include carrier wave signals on propagated signals in telecommunication and/or network distributed systems. These propagated signals may be computer (i.e., machine) data signals embodied in the carrier wave signal. The computer/machine data signals may include data or software that is transported or interacts with the carrier wave signal.

It will be apparent to those of ordinary skill in the art that many more implementations are possible within the scope of this invention than those set forth above. Accordingly, the invention is not to be restricted by the described implementations. Further, the invention is not to be restricted to the described implementations and uses of an ISS, whether implemented in hardware, software or any combination thereof, but is intended to encompass any ISS that is capable of receiving, recognizing, handling, or processing a data in association with a data identifier, whether implemented in hardware, software or a combination thereof.

1. A method for associating data with an identifier that allows a customer to complete a commercial transaction using the identifier to retrieve and process the associated data using the identifier, the method comprising collecting data and associating an identifier with the data, storing the data in a database, retrieving the data associated with the identifier in response to a request from a third party system and providing the data to such third party system in a format that can be utilized by the third party system to facilitate a commercial transaction.

2. The method of claim 1 where the identifier further includes a security code that prevents a third party system from obtaining certain data associated with the identifier absent accompanying the identifier with the security code.

3. The method of claim 1 where the data associated with the identifier is contact data.

4. An information sharing system comprising:
a database;
a data collection module that collects data from different sources, associates collected data with data identifiers and stores the collected data and its associated data identifiers in the database;
a data dissemination module that receives a data identifier from a requester, retrieves collected data associated with the data identifier and provides the collected data associated with the received data identifier to the requester in a format that will allow the requester to process the collected data; and
a transaction processing module that will process commercial transaction based upon the collected data.

5. The system of claim 4 where the collected data is product information.

6. The system of claim 4 where the requester is a user application.

7. The system of claim 4 where the requester is a person.

8. The system of claim 4 where the requester is a website.

9. The system of claim 4 where the identifier is randomly generated.

10. The system of claim 4 where the identifier is assigned by the data collection module.

11. The system of claim 4 where the identifier is assigned by the data source.
